(19) United States
(12) Patent Application Publication
(10) Pub. No.: US 2020/0188732 A1
(43) Pub. Date: Jun. 18, 2020

(54) Wearable Body Monitors and System for Analyzing Data and Predicting the Trajectory of an Object

(71) Applicant: Benjamin Douglas Kruger, Lexington, KY (US)

(72) Inventor: Benjamin Douglas Kruger, Lexington, KY (US)

(21) Appl. No.: 16/732,462

(22) Filed: Jan. 2, 2020

Related U.S. Application Data
(63) Continuation-in-part of application No. 15/473,125, filed on Mar. 29, 2017, now Pat. No. 10,548,511.

(51) Int. Cl. A63B 24/00; G06F 3/01

(52) U.S. Cl. CPC A63B 24/0006; A63B 24/0062; A63B 2024/0068; G06F 3/017; A63B 2024/0009; G06F 3/011

(57) ABSTRACT

A method of analyzing data obtained from sensors 200 worn on the body of an athlete. The sensors 200 provide both location and physiological data. The sensors 200 provide data to a server that can analyze the movement of the athlete and compare it to prior movement or optimal movements. The computer program can determine better motions 300 to optimize performance based on the motion 300 data from the sensors 200. The program can also determine physiological changes for the athlete, such as for example increasing leg strength, to optimize the performance. The program can also analyze and predict the trajectory 805 an object based on the data obtained regarding the athlete's movements and capabilities.

### CROSS REFERENCE TO RELATED APPLICATIONS

This application claims priority to U.S. provisional application Ser. No. 62/3 15,097, filed on Mar. 30, 2016, and incorporated herein by reference.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC

Not Applicable

### BACKGROUND OF THE INVENTION

### Field of the Invention

This invention relates to a system and method of using body monitors on an athlete for analyzing and improving athletic performance, storing and analyzing the date obtained from the body monitors for producing bio-feedback and recording and analyzing body motion 300, and for predicting the ultimate trajectory 805 of an object.

### BACKGROUND OF THE INVENTION

The invention relates to methods and apparatus for sports training. In particular, a trajectory 805 prediction, analysis and feedback system is provided for an object launched, impacted, or released by a human and provides feedback regarding the trajectory 805 of the object.

Most standards of a player's success are determined upon their consistency of controlling the trajectory 805 of the object used in the game. To truly become a better athlete, one must understand how each body part's motion 300 is effecting the trajectory 805 of the object, how each consistency of the body part's particular motion 300 is affecting the trajectory 805 of the object, and how physiological conditions are affecting the trajectory 805 of the object.

Users use a variety of techniques to improve their performance. Practice, sport specific strength training, and sport specific diets are all very common. Throughout history, coaches have attempted to determine the best way to perform a specific athletic endeavor. Many coaches prefer a hands-on approach when analyzing a user's athletic performance. Many coaches use the so called “eye test”, meaning they watch the motion 300, and provide feedback to the user. Coaches based their feedback on prior history and knowledge of watching different approaches that worked for different users. This method turns into trial and error and a lot of frustrating moments throughout the process. One disadvantage to this method is the amount of time it takes a human being to blink and the amount of time it takes an experienced user to complete a motion 300 like a swing 300. These two can overlap and cause problems in the coaching process. Another disadvantage is coaches are unable able to accurately decipher the current physiological scenario of the user, including the amount of muscle fiber activation rates, amount of lactic acid, amount of fatigue, the current heart rate, and other variables which significantly affect the particular motion 300, and in tum the trajectory 805 of the object. The last disadvantage of the eye test is the instructions can be “lost in translation”. By attempting to show the user how to correctly preform the motion 300, the coaches motion 300 will not be an exact replica of what the coach thinks the motion 300 should be. There will be deviations in the process, which leads to confusion.

Other coaches use video cameras to record the user and show the user what they did wrong. The major disadvantage for this process is, even though we can repeatedly study the user's motion 300, the internal body features are unknown. We are still using the “eye test” based on other users' performances to better the user's motion 300.

Modern technology has vastly improved the ability to train a user to perfect the various aspects of his or her sport. It is common to video record users and allow them to see themselves in action. This allows the user and a coach to evaluate every aspect of the user's performance, from their fundamentals to their game related behavior. A basketball player can watch game tapes to see how they were shooting, and to evaluate, in slow motion 300, what they did wrong during a particular shot.

There are now numerous sensors 200 that can be used to assist users. The most common and well known is the FitBit® which measures the number of steps a person takes, but can also measure heart rate, blood pressure and body temperature. All of that data can help a user and coach evaluate the user's performance. Another common technique is to apply video sensitive tape (or tight-fitting clothing 100 with video sensitive reflectors) and video the user during simulated aspects of their sport-a golf swing 300, a pitcher throwing-and develop a computer model of the specific user's body movement. This can be done for every aspect of the particular user's sport. This allows the coach to evaluate the specific body movements for efficiency and maximum performance. Runners, for example, can determine the most effective leg movement to increase speed or endurance.

The exponential growth in technology provides new ways to analyze athletic performance. There are a number of different sensors 200 that can be attached directly to the user's body, or equipment 802, to provide data on the user's movement during a specific athletic event, such as swinging 300 a golf club 802. These sensors 200 can be attached directly to the skin by use of tape. These sensors 200 can also be attached to the clothing 100 that the user wears. The three most common types of sensors 200 are the inertial monitoring unit, the IMU 202, and the surface electromyography, or SEMG 201, monitors, and electrocardiogram, or EKG 201, monitors. The SEMG 201 monitors muscle fibers, through surface electromyography SEMG 201. The EKG 201′s main function is to monitor the said user's heart rate. The IMU 202 monitors the said user's motion 300.

These sensors 200 can provide a good deal of information about an user's body motion 300 while performing an athletic task, like swinging 300 a golf club 802, throwing a pitch, shooting a basket, and the like. This information can be used to help the user improve performance. It would be valuable to further analyze this data to help the user improve performance by incorporating strength training and diet.

### SUMMARY OF THE INVENTION

This invention is the apparatus and methods to predict the trajectory 805 of an object in a real time after an ergonomic or athletic motion 300 is captured by sensors 200. The sensors 200 capture and analyze the body movements of the user 600, as well as specific the physiological conditions of the user's body 600, such as heart rate, muscle activation, and other electromagnetic activity results within the user's muscles and heart. The invention's sensors 200 are contained in skin tight clothing 100 worn by the user. The sensors 200 transmit information to a separate preferred method 205, more specifically a computer, tablet, or cellular device. From which, the data 300 is sent to a server 205 which contains software that records 400, analyzes 600, predicts the trajectory 805 to a specific motion 300, and archives the data 450. Such analyzed data 600 is finally sent back to the preferred method 205 to display 900 the results of the trajectory analysis 805 and biofeedback 710 pertaining the trajectory analysis 805.

The biofeedback 710 provides information to the user to allow them to modify their movements 300 and obtain their desired trajectory 700 more consistently. This said optimal motion 708 is produced by combining different body part's motions 300 from multiple historical motions 450 or searching a database of archived motions 450 and comparing trajectory analysis 805. The process also uses the historical data 450 to predict how the users' trajectory 805 can be improved by modifying their body through weight adjustment or strength training. The process is able to tell the said user, for example, the exact amount of added performance 707 if their right triceps brachii increased in strength by 7%, and to achieve this, the user should engage in a personalized strength training program. The process is also able to tell the user, based on historical physiological data 600 recorded from the specific user, that the advised strength training program will be most effective if the user modifies his or her diet.

The inventions process allows any user to teach their favorite training program, trick shot, athletic motion 300, workout program, ergonomic trade secret, or any other motion 300. The coaching process includes the producer of the motion 300 would have to wear the garment 100, performing their motion 300, labeling the motion 300, and archiving the motion 450 via their preferred method 205. This archived motion 450 is then available to be viewed on any system clients 900. This instantly connects the best coaches to predecessors all over the world.

### DESCRIPTION OF THE DRAWINGS

FIG. 1 is a flow chart of a method for using data collected from sensors 200 for the purpose of predicting the trajectory 805 of an object and providing bio feedback using a trajectory 805 analysis and detection system

FIG. 2 is a flow chart of a method for trajectory 805 prediction

FIG. 3 is a flow chart of a method for producing an optimal motion 708 during a trajectory analysis 805 and detection system

FIG. 4 is a flow chart of a method for machine learning during a trajectory analysis 805 and detection system

FIG. 5 is an information flow diagram for the apparatus of the invention during a trajectory 805 analysis and detection system

FIG. 6 shows the location of the microcontroller (including the IMUs 202) 202, and the electrodes 201 on the front of the compression shirt 100

FIG. 7 shows the location of the microcontroller (including the IMUs 202) 202, and the electrodes 201 on the back of the compression shirt 100

FIG. 8 shows the location of the microcontroller (including the IMUs 202) 202, and the electrodes 201 on the front of the compression pants 100

FIG. 9 shows the location of the microcontroller (including the IMUs 202) 202, and the electrodes 201 on the back of the compression pants 100

FIG. 10 shows the location of the microcontroller (including the IMUs 202) 202, and the electrodes on the front of the compression shorts 100

FIG. 11 shows the location of the microcontroller (including the IMUs 202) 202, and the electrodes 201 on the back of the compression shorts 100

FIG. 12 is a flow chart of a method for producing an optimal motion 708 and optimal workout 750 after a trajectory analysis 805

### DESCRIPTION OF THE INVENTION

The invention uses data 300 collected through sensors 200 to calculate the specific 300 movement and performance of an end user 600, to predict the trajectory 805 of an object. These sensors 200 include from surface electromyography 201, also referred by SEMG sensors 201, Electrocardiogram 201, also referred to by EKG 201, and Inertial Measurement Units 202, also referred by IMU sensors 202, which are a combination of two or more of accelerometers, gyroscopes, magnetometers, and barometers. These sensors 200 are embedded in or are attachable to clothing 100 worn on the user's body. The data 300 is collected and sent wirelessly from a microcontroller 203, which is attached to the clothing 100, to a preferred method 205, either a cellular device, tablet, or computer. The data 300 is then sent to a server 205 to be processed. Finally, the data 300 is sent back the preferred method 205 to be displayed 900. The server 205 uses the data 300 collected to predict the trajectory 805 of an object given an athletic or ergonomic motions 300. The inventions process also uses the trajectory results 805 and correlates the trajectory 701 with each body parts specific motion 300, each specific muscles exact muscle fiber activation rate 300, the user's heart rate 300, and their respective analytics 600. Through the correlation 701 and analytics 600, the process has the ability to introduce an ‘optimal motion’ 708. The ‘optimal motion’ 708 is the exact ergonomic or athletic motion 300 that will most consistently provided the user with their desired trajectory 700.

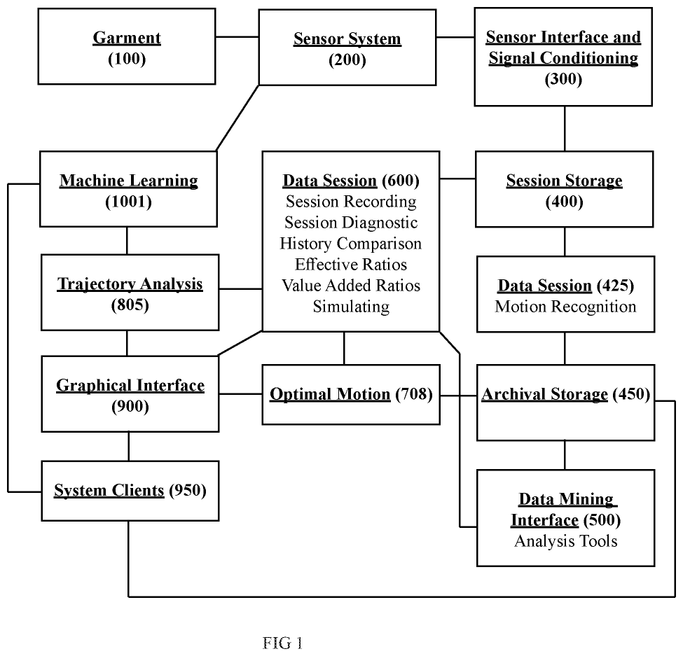

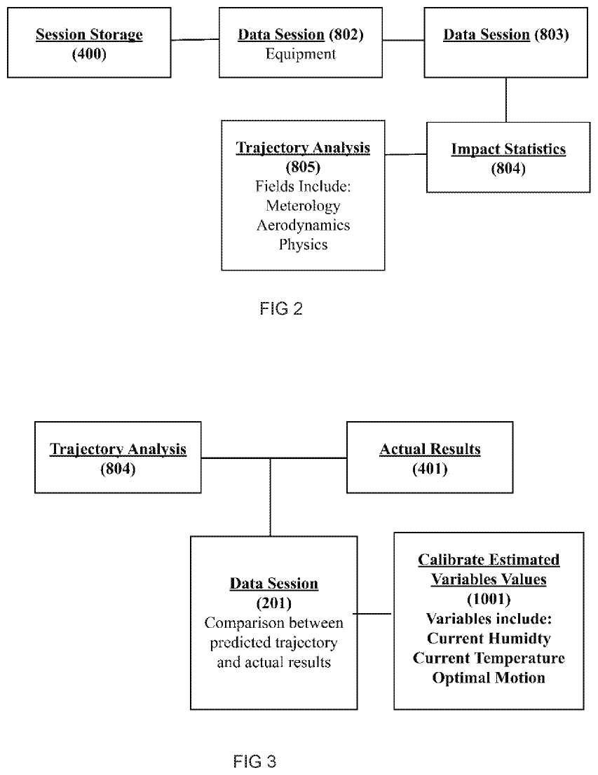

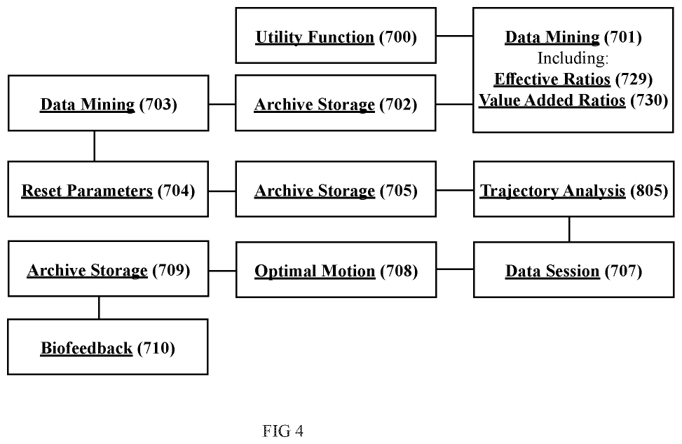

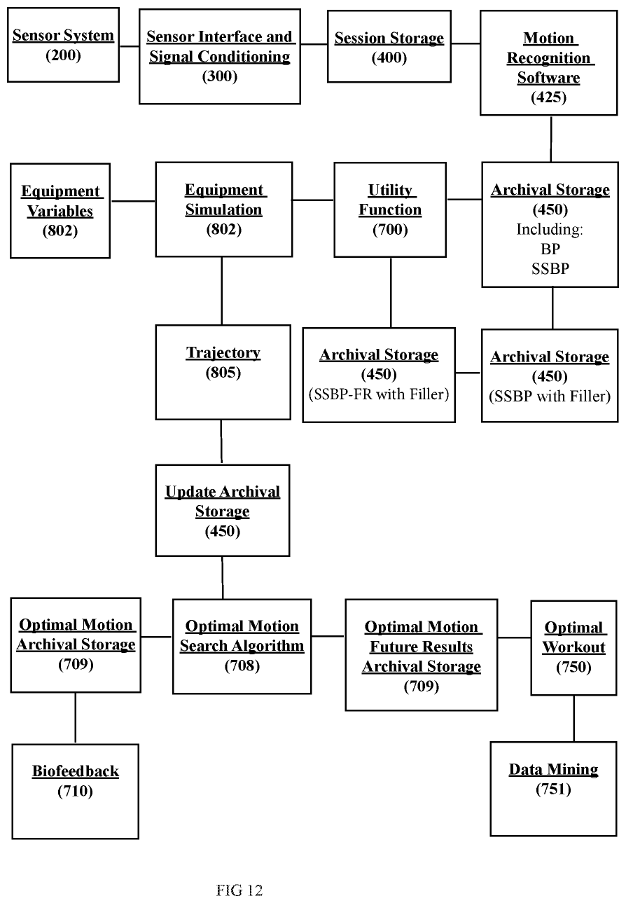

FIG. 1 is a flow chart of a method for using data collected from sensors 200 for the purpose of predicting the trajectory 805 of an object and providing bio feedback using a trajectory analysis 805 and detection system. FIG. 2, FIG. 3, FIG. 4, and FIG. 5 show more details of specific processes included in FIG. 1. FIG. 2 is a flow chart of a method for trajectory 805 prediction and visually shows the steps for the prediction process. FIG. 3 is a flow chart of a method for producing an optimal motion 708 by using the method of predicting a trajectory 805 of an object. FIG. 11 is another flow chart to produce the optimal motion 708. FIG. 11 also shows a flow chart of the optimal workout 750. FIG. 4 is a flow chart of a method for machine learning during a trajectory analysis 805 and detection system. This process is used when updating 1001 variables for the trajectory 805. It is also used when back testing the theoretical optimal motion 708 against an actual motion 300. FIG. 11 is another flow chart to produce the optimal motion 708. FIG. 11 also shows a flow chart of the optimal workout 750. FIG. 5 is an information flow diagram for the apparatus of the invention during a trajectory analysis 805 and detection system. This shows the connection between the sensors 200 and the order the data is relayed.

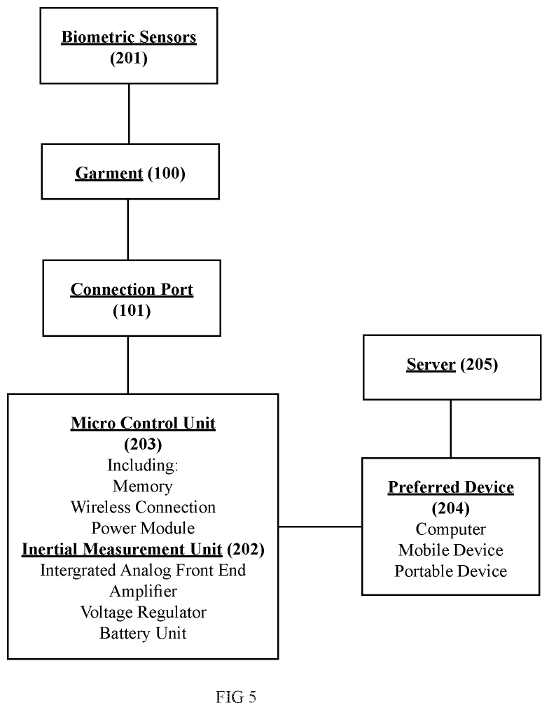

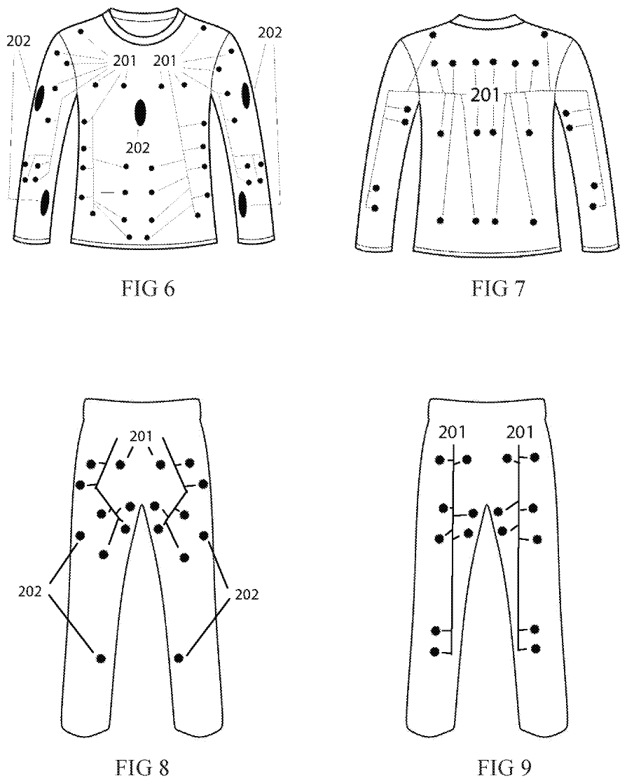

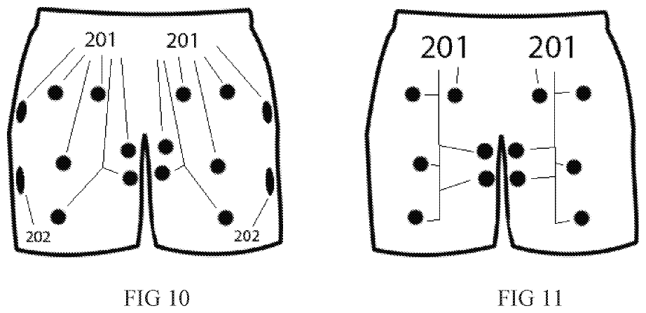

FIG. 6 and FIG. 7 show the location of the sensors 200 in the shirt 100. The sensors 200 are electrodes used in the Surface Electromyography, or SEMG 201, and Electrocardiography, or EKG 201. The sensors 200 are attachable to microcontrollers 203 that consist of at least an inertial measurement unit, or IMU 202, memory, Wireless Connection, Power Module, Integrated Analog Front End, Amplifier, and a Voltage Regulator. FIG. 8 and FIG. 9 show the location of the sensors 200 in the compression pants 100. FIG. 10 and FIG. 11 show the location of the sensors 200 in the compression shorts 100. There are two articles of clothing 100, a shirt and compression pants, or compression shorts. The clothing 100 is skin tight to allow the sensors 200 to be directly against the user's skin. The sensors 200 can be incorporated into the clothing 100 by sewing or other appropriate methods.

Processors may be one or more conventional processor, like a CPU or GPU, or other including, but not limited to, an ASIC, FPGA, or other hardware based processors. Processors may or may not work in parallel with other processors. Processors may execute any code, or instructions. This includes portions of instructions in some cases. For example, a processor may only execute a portion of a set of instructions to save time and processing power.

The executable code may be stored in an external memory, on a processor, or any other such. Executable code may give instructions directly or indirectly from the processor. These instructions, or executable code (which are used interchangeably throughout), may be loaded onto any processor, external storage, and/or other through, but not limited to, a USB Cable, Bluetooth, Bluetooth Low Energy (or BLE), RFID, WiFi, or NFC. The instructions may be stored in object-code format or any other computer language.

Instructions from the processors, or such, may or may not change the sampling rate for any reason. Some reasons include, but are not limited to, noise reduction, power management, or any other such reason. For example, if noise artifacts are highly present, a set of instructions may or may not change the sampling rate to receive less values and more accurate results.

The memory stores any information including, but not limited to, algorithms, instructions, data, or other. The memory can be defined as anything capable of storing information and having that information retrieved from a processor. The memory can store information from one or more processors. The memory protects against overwriting, clocking, corrupting, interrupting, or any interference between any application, the sensor system, application processor, or any other components.

Data storage, archive storage, or a database (all of which are interchangeable) may store information, data, analytics, algorithms, or any other type the archive storage can read. The data can be formatted in any computing device readable format. The data may be retrieved, stored, or modified by instructions from a process or such.

Communication between any application, the sensor system 200, the application processor, or any components may be wired or wireless. Wireless communication includes, but not limited to, Bluetooth, Bluetooth Low Energy (BLE), WiFi, ANT, WLAN, Powerline networking, and cell phone 204 networks. Communication may or may not be bi-directional. Communication may transmit, communicate, push data to other devices, receive, request, pull data, and store data. Communication may act as a relay between devices and/or the internet. Communication may also include NFC, RFID, and other such.

Location can be calculated from a Global Positioning Device (or GPS), IMUs 202, laser based locational systems, LIDAR, camera-based localization systems, or anything related. The location can also be calculated by sensor fusion to increase accuracy. The sensor fusion can use algorithms like a Kalman filter, a convolutional neural network, a Bayesian Network, Central limit theory, or any other algorithm used for the purpose of uncertainty reduction. An example of information calculated from a locational based method is the longitude, latitude, and/or altitude position.

The data signal processing (or DSP) circuitry may include, but is not limited to, a MCU. The processor may or may not include or instruct a particle filter, a Kalman filter, a convolutional neural network, a Bayesian Network, Central limit theory, or any other algorithm used for the purpose of uncertainty reduction. The DSP can be implemented via instructions from a hardware, firmware, software, or any combination of the three.

The data may be displayed visually through a digital display. Such display include, but are not limited to, LED, LCD, Preferred Personal Device, Flexible display attached to the clothing/garment 100, and other display technologies. Any information, including data, may be displayed on a screen connected with the processors. These may be wireless or wired in to transmit data. This data can then be visually displayed, but in some cases the data will be conveyed through audio feedback. The audio feedback can be convey on any speaker connected to the processors.

The location of each Inertial Measurement Unit, or IMU 202 (used interchangeably), is also essential to this invention. FIG. 1 shows the locations of the sensors 200 on the front of the shirt and shorts 100, while FIG. 2 shows the locations of the sensors 200 on the back of the shirt and shorts 100. These locations were picked because they can decipher 600 the exact motion 300 for the body at any given time. The IMU 202 consists of, but not limited to, an accelerometer, gyroscope, and a magnetometer. The data and states of the IMU 202 can be obtained and stored. The accelerometer can measure the acceleration around a 3D axis. The gyroscope can measure the angular velocity of the unit. And the magnetometer is used to measure the Earth's local magnetic field. By placing the IMUs 202 on a specific location on the body, the motion 300 of the body can be measured.

The states of the IMU 202 are then given instruction from the processor to calculate the angles of X, Y, Z. The process can use a variety models including using quaternions models. These models convert the raw states of the IMU 202 to analyzed data, which is in turn used for metrics and kinematics. Some metrics include, but is not limited to, the linear acceleration of a body segment and the angular velocity of a body segment.

Before the measurements are accurate, a calibration process needs to occur. In general practice in the industry, there have been three widely excepted IMU 202 location calibration procedures. These procedures include the static pose, functional calibration, and technical calibration. The static pose calibration requires the user to take a unique stationary pose. The functional calibration requires the user to complete a motion 300 around an imaginary axes. The technical calibration requires manually aligning the IMUs 202 with the bone structure. There are also other calibration procedures, not as widely accepted, but have been proven to be affective.

The sensor fusion algorithm assumes that the human body parts, or segments (used interchangeably), are rigid bodies. By making this assumption, a kinematic chain can be formed. The kinematic chain uses joint constraints to make the sensor fusion more accurate and modelled more like a human motion. Kinematic chains is more accurate by helping to prevent the drift of body segments over time. Although the kinematic chains are favored, the scope should not exclude free segment models.

The kinematic chain joint constraints are calculated at the beginning of using the invention the first time. The invention requires a set of motions 300 to be completed to decipher variations in natural flexibility in each direction for each specific joint. Similar to completing static poses to calibrate the IMUs 202, the invention requires a series of stretches and movements to calibrate the joint constraints. By solving for the joint constraints and completing correct kinematics using joint relation, unbounded integration drift is prevented. The kinematic chain also includes position and rotation constraints. The position and rotation constraints limit the drift due to the clothing 100 moving during the motion 300 or soft tissue artifacts.

The kinematic chain integrates all sensors 200 and their metric 600 including, but not limited to, muscle torque and acceleration. By considering integrated acceleration data, tracking for different movements and scenarios, like jumping and climbing a hill, can be calculated. By considering SEMG 201 values and metrics, a realistic movement can be calculated and a reduction in drift is achieved. The sensors 200 fusion allows the IMU 202 data to be cross referenced with the expected movement and its metrics when considering the muscle fiber activation. More specifically, a movement and its metrics 600, including velocity, should render a muscle fiber activation rate value in a combination of physiological cross sectional areas (or PCSA).

Some key body segments, including fingers, hand, feet, and head may or may not be monitored by sensors 200. In the scenario that a key body segment is not monitored by sensors 200, the key body segment's movement is estimated and included in the motion 300 database. Through algorithms similar to gait, or motion (used interchangeably), recognition, the algorithm is trained to associate key muscle fiber activation rates and movements with a simulated key body segment movement. The training data is collected through a series of motions 300 that are instructed to be completed through the display 900. That data allows the processors to look for key indicators of monitored body segments that correspond with the simulated body segments motion. The simulated gait recognition may use models including, but not limited to, generative adversarial networks (or GAN), Convolutional Neural Network (or CNN), Long-Short-Term memory (or LSTM), generalized recurrent units (or GRU), artificial neural network (or ANN), Bayesian Probability, genetic algorithms or any combination or such.

For example, the hand position is calculated by the combination of the IMUs 202 and the muscle fiber activation rate in key areas including the forearm. The forearm SEMGs 201 uses the motion recognition algorithm 425 to decipher the location and path of the fingers and wrist. These muscles are called extrinsic hand muscles, or more specifically include, but are not limited to, the Flexor Carpi Ulnaris, Palmaris Longus, Flexor Carpi Radialis, Pronator Teres, Flexor Digitorum Superficialis, Flexor Digitorum Profundus, Flexor Pollicis Longus, Pronator quadratus, Aconeus, Brachioradialis, Extensor Carpi Radialis Longus and Brevis, Extensor Digitorum, Extensor Digiti Minimi, and Extensor Carpi Ulnaris. The abduction, adduction, extension, and flexion movements of the muscles are used to calculate the location of the wrist and fingers through the motion recognition algorithm 425. The training data for the individual is a simple test, which is occurs usually at the beginning of collected data, or first time the garment 100 is being worn and data is collected through the sensors 200. For the hand example, the user will be asked to complete a series of finger and wrist motion 300 which will be used to decipher the motions 300.

The location of the SEMG 201 sensors 200 allows the process to monitor the muscle fiber activation rate 300 for a select group of muscles. This is measured by the electromagnetic activity 600 in the muscles. The higher the activation rate, the more muscle contraction is evident. The invention also monitors for the increase in the activation rate of muscle fibers that are not used to their full potential 600, which is different from muscle hypertrophy. Muscle hypertrophy by definition is the increase in size of skeletal muscle through a growth in size of its component cells. The patent will coin the term muscle hypertrophy for both scenarios, even though they have different meanings. The goal is to obtain a higher activation rate through added muscle fibers or tapping into dormant muscle fibers when considering the Optimal Workout process 750. This invention monitors and analyzes the changes in the activation rate of muscle fibers in the monitored muscles.

By monitoring the changes in muscle fiber activation rate, this invention also accurately calculates 600 the fatigue of each monitored muscle, amount of possible force per muscle, which muscles are stronger than others, which muscles are used most often during an ergonomic or athletic motion 300, which muscles contribute to the trajectory 805 of an object 805 the most, and which muscles are more susceptible for muscle hypertrophy. A clear sign of fatigue is the decrease in activation rate for fast twitch muscle fibers. These muscle fibers produce a signal of 126-250 Hz. The amount of force per muscle is calculated 600 by dividing the Newton's force by the cross-sectional area of the muscle. The amount force is than compared to all other muscles to decipher which muscles are stronger than the others. During a motion 300, the force divided by time t allows the process to decipher which muscles are most active. To tell the effects of fatigue for that particular user for the particular motion 300, the invention calculates the deviations of the motion 600, using the IMU 202 data against the amount of fatigue. By comparing the fatigue of the specific muscles and their effect on the trajectory 805 the process deciphers how each body part reacts to fatigue and by a specific amount 600. Furthermore, the invention can provide training to reduce fatigue or a change in motion 300 to compensate for fatigue. The training process minimizes the amount of fatigue given historical data 450 on how the specific user's muscles responded to a workout.

While lifting weights or performing an athletic motion 300, the activation rate of muscle fibers can be a clear sign of many key analytics 600 including, but not limited to, the maximum amount of force, the maximum amount of force velocity, and the time until fatigue occurs for the specific muscle. Since muscle fibers are responsible for movement, the velocity and the force of the motion 300 directly relate to the increase in muscle fibers. By using historical data 450, the process can estimate the amount of changes in force, velocity, and flexibility during fatigue or if muscle hypertrophy occurred. The process uses a regression equation to estimate the added amount of max velocity with respect to the fast twitch and slow twitch muscle fibers. For example, the regression equations stipulates that the user, on average, will increase velocity by X and force by Y for each increase in muscle fibers. During a motion 300, the percent of activation for each muscle 600 is a clear indicator which muscles are essential to the completion of the motion 300. If a lower than normal activation rate is noted, it can mean that there is wasted potential energy, but the process checks the increase in margin of error for each increase in muscle fiber activation for that muscle. The invention uses equations like the industry standard Force-Velocity model. It states that as the velocity of the muscle contraction increases, the force output decreases. Typically this equation is

F=F₀b−av/b+v Equation 1

Where F is the instantaneous force, F₀ is the force produced in isometric contraction, v is the current contraction speed, and a and b are constants.

Similarly to the SEMG 201, the electrocardiogram 201, or EKG 201, measures the electromagnetic activity. Instead of measuring the electromagnetic activity of a muscle, the EKG 201 or ECG 201 measures the electromagnetic activity of the heart 300. This data is used primarily for monitoring the heart rate of the user. Other analytics include the estimated respiration rate and monitor abnormalities. These abnormalities include heart attacks, a murmur, seizures, cardiac dysrhythmias, fainting, and other abnormalities. Even though the process searches for key signs in the abnormalities, the main purpose to monitor the heart rate through the ergonomic or athletic motion 300.

Common problems include baseline wander, power line interference, and noise correction. Baseline wander is a low frequency noise that has non-linear or non-stationary tendencies. Baseline wander can be solved by a cut off frequency at 0.05 Hz, using a capacitor, or a high pass filter in the software. Power line interference is caused by electromagnetic fields (EMF), electromagnetic interference by a power line, alternating current fields, improper grounding, or things like air conditioners. It can be fixed by a notch filter at 50/60 Hz in the software. Nosie correction can use a flexible digital filter block to fix it.

Some other filters to consider, but not limit the scope to, are infinite impulse response filters, finite impulse response filters, adaptive filters, or a wavelet transform filter. A high pass filter removes low frequency signals. A low pass filter removes high frequency signals. An example is a Gaussian impulse response, which is a time varying low pass filter with variable frequency.

The EKG 201 may or may not use signal recognition algorithms in this invention. The algorithm collects the filtered data and separates the points, segments, intervals, waves, and complex into separate matrices. The algorithm runs statistical analysis on the individual matrices to compare current results with past results and to find statistical trends in the signal. Some examples include the amount of duration of intervals, amplitude of waves, beats per minute, and interval voltage. The statistical analysis metrics are then compared to the norm with the individual and common warning signs. A common warning sign is if the P wave amplitude exceeds 3mm or 0.3mV. If it does exceed those nominal values it represents right atrial enlargement. Any abnormalities, with respect to the activity levels (calculated from the IMUs 202 and SEMG 201), will immediately be displayed on the preferred device 204. The signal recognition algorithm can also be compared to the activity and will provide insights of the performance.

As formally introduced by the simulated body segments, the motion recognition algorithm 425 uses a model or a series of algorithms to decipher what motion 300 is being performed. For example, the algorithm is able to distinguish between a baseball throw, a golf swing 300, and a runner. The motion recognition algorithm 425 is used numerous times and in numerous ways throughout the prediction of the trajectory 805 of an object and the optimal motion 708 which is desired. An example includes recognizing a real time motion 300 for the purpose of comparing deviations between the optimal motion 708 and the real motion 300. Another example includes creating a Sport Specific Biometric Profile 450 from the overall athletic Biometric Profile 450 of the user. As stated before, gait, or motion 300, recognition, may use models including, but not limited to, Convolutional Neural Network (or CNN), Deep Convolutional Neural Network (DCNN), Long-Short-Term memory (or LSTM), generalized recurrent units (or GRU), artificial neural network (or ANN), Bayesian Probability, genetic algorithms, Support Vector Machines, Naïve Bayes, Multi-Layer Perceptron, Random Forrest or any combination or such.

In a simple model the motion recognition algorithm 425 uses multiple motions 300 as a framework for the algorithm. Meaning a user will complete and label different golf swings 300. The IMU 202 values of the golf swings 300 are archived 450 and a large standard deviation is applied to those values. This builds the frame work for an archived motion 300 recognition process, or range of motions 300 considered a golf swing 300. The IMU 202 ranges, or IMU 202 values with the large standard deviation applied, are used to track when a motion 300 occurs. More specifically, the IMU 202 ranges, with respect to time t, create a data set, or parameters, to test every motion 300 against. For example, a golf swing 300 has key attributes each IMU 202 will follow. The golf swing 300 will deviate throughout the round and will completely change over time, but the overall key attributes of the golfers swing 300 will always be recognizable through the IMU 202 ranges. When a motion 300 is recognized, the archived data will be labeled for future data retrieval. Using the motion 300 recognition and analytics 600 throughout the motion 300, this invention claim's the ability to predict the trajectory 805 of a motion 300. For example, the predictions 805 include, but are not limited to, the flight of a golf ball, the motion 300 of a kayak given the users paddle motion 300, and the risk of injury of a worker lifting a 50 pound box repeatedly. The invention continuously updates the repeated motion's data 300 and develops analytics 600 on the motion 300 to inform and improve the user's ergonomic and athletic motion 300.

The Athletic Biometric Profile 450 is a user unique and personal profile of all data collected on them through the sensors 200. This includes every motion 300, its respective metrics, and combined metrics of multiple motions 300. This personal motion 300 database contains all motions 300 ever attempted by the athlete and their respective metrics on the motion 300. This database is not limited to a specific motion 300 or only ergonomic or athletic motions 300. This database contains every motion 300, their EKG 201 values, and their SEMG 201 values.

In one variation, a motion recognition algorithm 425 is applied to the Athletic Biometric Profile 450 to sort motions 300 from the bulk data. By completing the motion recognition algorithm 425, a Sport Specific Biometric Profile 450 is produced. The Sport Specific Biometric Profile 450, or sport specific database 450 (used interchangeably), is defined as a database of similar ergonomic or athletic motions 300 categorized by a motion recognition algorithm 425, by user input, or by key signals before or after the ergonomic or athletic motion 300. An example of a key signal is if before shooting a free throw a user spins a ball in his or her left hand. By searching for the key signal, the software is able to decipher a free throw basketball shot from a practice attempt when the user has no ball.

In another variation, the sport specific database 450 is creating the same time as the Athletic Biometric Profile 450. When the real time motion 300 is collected, the users' data can go to the Athletic Biometric Profile 450 and the Sport Specific Biometric Profile 450. The data will go to the Sport Specific Biometric Profile 450 when the motion recognition algorithm 425 recognizes the motion 300 as such.

The Sport Specific Biometric Profile 450 is used in the optimal motion process 708. By creating a database 450 of all possible motions 300, real and simulated data, the optimal motion 708 can begin testing every option to produce the best possible motion 300 given the users unique Utility Function 700. This process will be revisited later.

The Athletic Biometric Profile 450 uses simulated data, or filler, to complete the Biometric Profile 450. The more the user wears the clothing 100 with sensors 200 in it, the more real data is collected and less simulated data is required. The simulated data estimates the values and metrics of motions 300 given the real data collected from the user. The simulated data can be calculated through various models and methods. The models include, but is not limited to, GAN models, reinforcement learning, and weighted statistical analysis based off of similar real data values. The GAN model includes training the generator and the discriminator from the real data from the user's motions 300. The data can include the motion 300, the metrics, the expected values, and others. The model is trained for the unique aspects and abilities of the athlete and produces statistical significant simulated data to complete the profile. Another method is using weighted statistical analysis using all previous motions 300 from the Athletic Biometric Profile 450 to estimate the data. The model is weighted based on similar motions 300 and estimates for unknowns like the influences other body parts motions 300 contribute to expected values. The models can also be combined to simulate the data. The motion 300 can be calculated using the GAN model, while the metrics of the motions 300 can be calculated using the weighted statistical analysis model. By some form of modelling, the Athletic Biometric Profile 450 is completed by using simulated data. As more real data is measured, the model can update and the real data can replace the simulated data.

The process 950 begins with said user being instructed to complete a task, for example swinging 300 a golf club 802 at a number of different angles. (This description uses a golfer and a golf swing 300 to illustrate how the invention works. However, the invention can be used with any sporting activity or ergonomic motion 300). The angles described in this section refer to the joint angles of the body. These angles are measured 600 by the timestamped IMU sensors' 202. The timestamped IMU 202 data is analyzed 600 and produces the velocity, margin of error, and amount of torque per body part while performing the motion 300. The timestamped SEMG 201 data is also collected 300 and analyzed 600, which shows how each specific muscles are responding 600 during the motion 300, which was described above. By using the SEMG sensors 200, the invention calculates the exact amount of muscle fiber activation in each specific muscle monitored 600. The SEMG 201 data 300 is then indexed based on the number of muscle fibers activated, the maximum amount of muscle fibers produced, the average amount of force each muscle fiber produced, and amount of fatigue 600.

The invention uses a cause and effect method for predicting the trajectory 805 of an object. The cause is the motion 300 and the motions 300 respective analytics 600. Such analytics 600 include the amount of force caused to the object at impact, the velocity at impact, the angle of impact, and more. The motion 300 and analytic effect the equipment 802 and in turn the Impact/Release 804. The “cause” aspect of the trajectory analysis 805 includes the equipment variables 802 such as the elasticity of the equipment 802, the center of gravity of equipment 802, the lead/lag of the equipment 802 at impact, the mass of the equipment 802, the compressibility of the equipment 802, the friction of the equipment 802, the shape of the equipment 802, and more.

The equipment 802 is defined as any object that the user comes in contact with or avoids during the motion 300. In other words, the equipment 802 is any object that effects the motion 300 or trajectory 805 of the user. Since the invention's scope covers the trajectory 805 of multiple ergonomic or athletic motions 300, the equipment 802 is broadly defined. An examples of equipment 802 include a basketball, a baseball glove, a baseball ball, a baseball bat 802, hurdles, and the floor for gymnastics, among others.

The “cause” begins with the sensors 200 calculating the motion 600 and then simulating the equipment 802 using the equipment variables 802 with respect to time t. The analytics from the simulation of the equipment 802 and their variables include the velocity of the equipment 802 throughout the motion 300, the elasticity of the equipment 802 (e.g. the lead/lag of a golf club shaft 802 through-out the swing 300), the aerodynamics, or external forces, on the equipment 802. The elasticity of the equipment 802 refers to how the equipment 802 responds to the motion 300. More specifically (in some scenarios like golf), how the motion 300 creates a center of gravity that causes the equipment 802 to bend. The elasticity of the equipment 802 is also used to calculate the velocity of the equipment 802. For example, the golf shaft bends and “recoils” throughout the motion 300. The invention uses the elasticity of the equipment 802 to accurately calculate the velocity of the club head and the location of the club head throughout the motion 300.

Equipment can be simulated in numerous different ways depending the type of equipment and the sport. Equipment that is simulated can include basketballs, footballs, golf balls, or anything such. For example, the process simulates the golf club's 802 axial deformation, the bending in the two transverse directions, and the angle of twist around the centroidal axis at time t. This example assumes the golf shaft is a Rayleigh Beam. By making the assumption the golf shaft 802 is a Rayleigh Beam, calculations for each body segment of the golf club 802 can be calculated. Calculations including, but not limited to, the amount of resistance, the amount of flex, and amount each body segment affects the other body segments. These calculations use the metrics including, but not limited to, the net directional force, net directional velocity, net directional angular velocity, the gravitational force, the internal elastic forces, which are described above. The simulations at any time t may have additional calculations and metrics calculated. These calculations and metrics may be used in the impact model.

In more detail, once the motion 300 and the motion recognition algorithms 425 have been completed, metrics and, if necessary, the simulated equipment 802 is solved for. The simulated equipment 802 uses nominal values and equations for variables including, but not limited to, mass, volume, elasticity, density, length, features like cavity of golf club head 802 and laces on a baseball 802. These nominal values and equations are entered into a physics simulator, along with the data and metrics from the motion 300, to simulate the location and “form” (shape of the club or other object is in). The physics simulator, or physics engine (used interchangeably), uses metrics like, but not limited to, force, torque, angular velocity, and aerodynamics to solve for how the equipment 802 will react with the motion 300.

An example is a simulated baseball bat 802 during a baseball swing 300. Before the simulation can occur, the user must enter what size bat they are using, the weight of the bat, the type of bat they are using (the brand and item name), and the type of grip they are using, among others. By using a database of information about the entered equipment 802 (in this case the baseball bat 802), inputs will be downloaded including, but not limited to, the mass of the bat, the bat stiffness, the bat damping parameters, the moments of inertia of each segments about axes x, y, z, the bat shape in the x, y, z direction, the equations for the bat aerodynamics, the bat surface area, the elasticity of the bat, features like cavities on top of the bat, and the coefficient of restitution equations. These downloaded values and equations, which are unique to the specific equipment 802, will be used to simulate the equipment 802 during the motion 300.

Once the information is prepared by instructions from the processors, the algorithm 600 is ready to be completed upon a motion 300 which is recognized, in this case a baseball swing 300. The recognized baseball swing 300 calculates metrics including, but not limited to, torque, angular velocity, velocity, path, directional force, propulsive force, center of gravity, and moments of inertia around each axis for each body segment. The hands location, path, and metrics were calculated above through the sensors 200. By considering the hands to be permanently connected to the handle of the bat, the non-rigid body, or baseball bat 802, directly responds to the motion 300 of the hands, per the industry standard. Each swing 300 produces a different flex of the baseball bat 802 and the baseball bat can be located at time t by solving the axial deformation, the bending in the two transverse directions, and the angle of twist around the centroidal axis 802. To calculate 802 the four variables, the movement of the body and equations for variables must be considered to solve the sum of forces acting on the bat.

To solve for atmospheric variables 803 including the sum of forces acting on the bat, the invention considers the aerodynamic parameter of the athlete and bat, gravity, air density, aerodynamics, lift, drag, and others. One method, known in the industry, for the aerodynamics of the batter and bat system is given by

$${K}_{D} = \frac{1}{2} ρ {C}_{D} D \frac{{L}^{4}}{4} \qquad Equation 2$$

Where ρ is air density, C_{D} is drag coefficient, D is diameter of the batter and bat system, and L is the length of the batter bat system. While the drag acting on an axial differential section, dx, is

dF(x)=½ρV(x)²C_{D}(x)d(x)dx Equation 3

Where V is the local air velocity, d is the diameter, x is the distance from the axis rotation, and C_{D} is the section drag coefficient.

The sensors 200 are necessary for accurately calculating the four variables of the equipment 802 (used in the models of a baseball bat, a golf club 802, and similar equipment 802) and some of the variables needed for the forces on the equipment 802. This example uses the torque, velocity, path, net directional force, net directional velocity, net directional angular velocity, gravitational force, internal elastic forces, and other metrics to solve for the four variables, while all models, or all specific motions 300 (e.g. basketball shot), use the sensors' data 300 to calculate variables 803 including aerodynamics of the motion 300. The invention claims every ergonomic or athletic motion 300 that requires trajectory analysis 805 has variables that are critical to the trajectory analysis 805 calculated from the sensors' data 300 during the process. The sensors' data 300 is used throughout the process to calculate many key aspects of the trajectory analysis 805. By using the sensors data 300 to accurately calculate the variables in the process, the invention is able to accurately calculate the trajectory 805 for any given motion 300.

Once the location of the equipment 802 at all times is calculated, the process calculates the impact statistics 804. These values include the impact velocity, the impact angular velocity, the impact angle, the compressibility of the equipment 802, the friction force, and the transfer of force. It also deciphers how the mass of the equipment 802 and the mass of the object react with each other. The impact velocity is Impact Velocity=Displacement/time of impact. The friction force calculates how much energy is lost due to friction. The transfer of force measures how much force remains. These variables and analytics are then processed to predict the trajectory 805 of the object.

The impact time and location 804 can be solved by two different approaches. One approach is to use sensor data to estimate the time of impact and then using the time of impact to find where the simulated baseball bat 802 was at that time. The approach uses values including the dynamic response of the baseball bat 802, which is the vibration of the bat after impact. These vibrations can be interpreted by the sensors 200 on the garment 100, and can imply impact at a specific time. Other variables that contribute to the impact of the bat and the ball include, but not limited to, recoil and others. The location and shape of the bat at impact can be calculated by solving for the four variables and using an industry standard equation

rₚ(x, t_{impact})=r_{b}(0, t_{impact})+r_{p/b}(x, t_{impact}) Equation 4

Where rₚ is the position of any point along the length of the shaft, r_{b} is the position of the athlete's hands, and r_{p/b} is the position of the base frame. Once the simulation location at time of impact is determined, the moments before and after the time of impact can be simulated to solve for values including velocity, angular velocity, and coefficient of restitution.

The other approach is a theoretical approach and is mostly used during the optimization aspect on the invention. The theoretical approach makes the impact location 804 a set location, e.g. top right corner of the strike zone at the front of the plate (the x, y, z). By making the set location, the optimization process can run through all possible motions 300 to solve for the best possible swing 300. The invention also allows the user to optimize their motion 300 based on the location of the impact. The user will have a different optimal motion 708 for a pitch when impact is located at the top right of the strike zone compared to the bottom left of the strike zone. Other options include different pitches and the z location of the impact (the location of impact when considering the z axis, how close the pitch is to the catcher).

This example of impact time and location 804 is for the unique scenario of using simulated equipment 802 which comes in contact with a phantom object 802. There are numerous different scenarios in the ergonomic or athletic worlds where equipment 802 needs to be simulated to predict the trajectory 805 but the common aspect of all scenarios is that the sensors 200 are used to calculate some or all critical values in the calculations of the moment of Impact/Release 804 and in turn the trajectory 805.

In general, the moment of impact 804, or Impact/Release 804 (used interchangeably), is defined as once the simulated equipment 802 contacts the phantom object 802, the user is no longer in contact with the simulated equipment 802, or when the user makes or avoids contact with the phantom object 802. The wide scope definition of the moment of impact statistics 804 is due to the wide range of trajectories 805 that need to be calculated in sports. This invention does not limit the scope of the motions 300 that requires trajectory 805 to optimize, but states that Impact/Release statistics 804 are required step in the invention.

An example of when the simulated equipment 802 contacts the phantom object 802 is in the case of a golf swing 300 or baseball swing 300. The simulated equipment 802, or golf club 802, contacts with the phantom object 802, or golf ball, at time t, which is determined by the club simulation and values or assumptions. The simulation, when in real time, assumes the location of the phantom object's 802 location, or golf ball, by tricks of the trade, like when the athlete addresses the ball before the motion 300 and/or the athlete is told the proper location the golf ball via the display. Other tricks include dynamic response, recoil, changes in MAUP, and other metrics collected from the sensors 200 to back test the assumed phantom location. One value calculated during the moment of impact 804, the impact force, may be calculated using the model

Impact Force=KX^{e}−CV Equation 5

Where K is the spring stiffness, X is the impact deformation, V is the impact deformation velocity, e stiffening exponent, and C is the damping factor. These values are calculated through the equipment simulation 802 and download from the equipment 802 database and the beginning of the process. Models such as these calculate the rest of the critical values of the moment of impact 804.

An example of the user being no longer in contact with the simulated equipment 802 includes the floor during gymnastics, the football during a throw, and a basketball during a basketball shot. In the basketball example, the basketball is being shot by the right hand with the left as a guide hand, attributing very little in terms of velocity, angular acceleration, or such. The athlete, when at the apex of his or her jump, flicks the wrist and causes the Impact/Release 804 metrics. Factors 804 including, but not limited to, the launch velocity (the jump, the extension of the elbow, and the flick of the wrist are considered in the calculations), the angular velocity (mainly from how the flick of the wrist causes the basketball to spin, or have angular velocity), the launch angle (measured from the IMU sensors 202, the SEMG 201, and the motion recognition algorithm 425, described above, of the hand and fingers), and the launch height (also measured from the IMU sensors 202, the SEMG 201, and the motion recognition algorithm 425, described above, of the hand and fingers). The launch velocity equation uses values from the sensors 200 in clothing 100, including the SEMGs 201 and IMUs 202 to calculate the moment of impact 804, or Impact/Release 804. The SEMG 201 collect 300 the data 400 and metrics 600 on muscle fiber activation and muscle torque, while the IMU 202 calculates 600 the cumulative velocity through key body parts.

The moment of Impact/Release 804 is also defined as when the user makes or avoids contact with the phantom object 802. This occurs when anytime the user's performance includes equipment 802 that cannot be described as an extension of the body and/or when contact with the equipment 802 is a prominent part of preparing the motion 300. An example for this category is catching a football, running hurdles, or kicking a football/soccer ball. These Impact/Release 804 values are mainly used in the theoretical aspect, but through tricks of the trade they can be used in a real time performance. It is also used mainly in the optimal motion process 708.

An example is kicking a football/soccer ball. The soccer ball is a phantom object 802 that the user makes contact with. The location of the soccer ball is not known to the software but can be theorized to predict different trajectories 805 at different impact statistics 804 for the unique athlete's motions 300. The sensors 200 collect information on what impact statistics 804 can be expected from kicking the soccer ball. This can be completed through tracking maximum and average impact statistics 804 of the athlete while kicking the soccer ball. The invention uses the same dynamic response, coefficient of restitution, and recoil techniques, discussed above, during the motion recognition software 425 to create the Sport Specific Biometric Profile 450 on a soccer kick. During the optimization phase 708, the soccer ball theoretically be in a specific location and different impact location and metrics is applied. This allows the athlete to simulate trajectories 805 and produce the most consistent motion 300 for their desired results 700.

In more detail, assume the athlete wants to kick 300 a free kick in the top left corner of the net in the most consistent way. The soccer is placed at a theoretical location in the 3D model. The optimization algorithm 708, discussed in more detail later, will test the user expected standard deviation on each kick, the expect velocity, launch angle, and more metrics. By using data from the sensors 200 from previous training sessions 450, the invention can produce different impact statistics and metrics 804. All of the different impact statistics and metrics 804 are then simulated to track the trajectory 805 of the ball, in the purpose to find which impact statistics and metrics 804 produce the final trajectory location 805 (e.g. the top left of the goal) desired by the user. Once the trajectories 805 are simulated and sorted by location in the goal, the invention sorts through the possible motions 300 to produce the most accurate (or consistent) and the most powerful (largest launch velocity), or the users unique desired combination 700. The optimization 708 with respect to the final location only searches motions 450 which impact statistics and metrics 804 produce the final location. The possible motions are compared to each other and the best motion is selected given the Utility Function 700. The display 900 then shows the motion 300 and is used for training purposes.

There are different methods and models to calculate the moment of impact statistics 804, which give the initial launch conditions, through the collection of data 300 from sensors 200 in or on a garment 100. Some models include, but are not limited to, the free-body assumption model, volumetric impact model, normal force model, impulse-momentum models, and the finite-element model.

An industry standard model of impact statistics 804 through an impulse-momentum model includes solving for 15 unknowns. The 15 unknowns include equations that solve for linear impulse and momentum, angular impulse and momentum, normal restitution, and kinematic constraints. This model uses a free body diagram and frames of reference for developing the equations. This industry standard model uses equations which include the velocity (before and after impact) and inertia. These equations use the simulated equipment 802 values in the calculations, which are collected through the process using the sensors data 300, as described above.

Before the prediction of the trajectory or flight 805, is calculated, the process downloads, or estimates, the atmospheric variables 803. Such variables 803 include, but are not limited to, the current gravity, wind, humidity, temperature, and the atmospheric pressures. After the motion 300 is completed and the atmospheric variables 803 are estimated, the process solves for the Impact/Release statistics 804. Such statistics 804 include, but are not limited to, the amount of spin, direction of the spin, and more. With respect to the atmospheric variables 803 and impact analytics 804, the lift, drag, gravitational force, speed of the ball, linear acceleration, angular acceleration, landing velocity (vertical, horizontal, and depth), rebound velocity (or bounce), friction of ground impact, coefficient of restitution at rebound, and the spin 805 are predicted. This process 805 gives the first predicted trajectory 805 given the atmospheric estimates 803 and the Impact/Release estimates 804. This trajectory analysis process 805 is then back tested and uses machine learning 1001 to reduce inaccuracies in the trajectory process 805.

Once the moment of impact's statistics 804 are found and calculated, the trajectory 805 of the object is then calculated. The trajectory analysis 805 is a physics engine that simulates the flight of object or user. The trajectory analysis 805 can be used during a real time motion 300 or to simulate trajectories 805 of multiple motions 300 from an archived database 450. The trajectory analysis 805 uses the impact statistics 804 to simulate the flight of the object and forces on the object during the flight to accurately calculate the complete flight of the ball. These variables include, but are not limited to, exit velocity, gravity, wind, humidity, temperature, atmospheric pressure, altitude, lift, Reynold's number, drag, angular momentum, angular impulse, kinetic energy, displacement, coefficient of restitution, friction, spin, and coefficient of variation. The variables influence the ball while in flight during the simulation according the instructions and equations.

A simple and efficient model for trajectory analysis 805 can be calculated through industry standard aerodynamic equations, which calculate the forces on the ball. The simple model can be calculated through equations that calculate the gravitational force, the drag force, the lift force, and the torque that opposes the spin of the ball. Once all the coefficients are solved for, the equations are projected onto a X, Y, Z coordinate system, or 3 dimensional space. The X, Y, Z coordinate system can be shaped as a Cartesian mesh or an unstructured mesh. The bottom side of the mesh can be set up as open ended or have a barrier representing the ground. The bottom barrier can be shaped to represent the current locations topography. The current location's topography can be calculated through use of cameras, satellites, or anything capable of imaging the land. The bottom barrier allows for better X, Y, Z locational values at time of Impact/Release 804. While the golf ball flies through the given X, Y, Z coordinate system, the forces on the ball effect the flight of the ball for an accurate trajectory analysis 805.

A more advanced industry standard physics engine is made up of a 3 dimensional space with inner areas inside the space. Given the moment of impact statistics 804 and equipment 802 variables, the physics engine analyzes the trajectory 805 of the ball through a series of equations that have influence on the object. These influences, or forces, on the object may or may not include the velocity of wind in each 3D direction, the direction of the wind, and the pressure of the air. Other forces including, but not limited to, the lift, the drag, the air density, the Reynold's number, and the gravity are factored into each inner area of the 3D spaces calculations. Each inner area have influence on the neighboring inner areas. The methods simulation can be calculated by numerous different models, including finite elements models, finite volume models, or any other model capable of the calculations. Other variables may be included, but for the industry standard model these are defined as the major forces in each inner area of the 3D space. This model can use the Euler method, or Naiver-Stokes equations.

Using the Naiver-Stokes equations, which calculates the correlation of velocity, pressure, temperature, and density of a moving fluid, governs the flow around the object. The equations are the extension of the Euler Equations and include the viscosity on the flow. The laws of conservation of mass and the law of conservation of momentum are considered in this model. After calculating the Naiver-Stokes equations, the trajectory 805 equation can be written as:

TF=LF+DF+G Equation 6

Where TF is the total forces acting on the object, LF is the lift, DF is the drag, and G is gravity. Movement can then be calculated from

$$\begin{matrix}{F}_{CD} = 0.5 ⋆ CD ⋆ ρ x ⋆ A ⋆ {V}^{2} & Equation 7 \\ {F}_{CL} = 0.5 ⋆ CL ⋆ ρ x ⋆ A ⋆ {V}^{2} & Equation 8 \\ {F}_{CD} + {F}_{CL} + m G = mx \frac{dV}{dt} & Equation 9\end{matrix}$$

Where m is the object weight, G is gravitational acceleration, t is time, CL is the coefficient of lift, CD is the coefficient of drag, p is air density, A is the cross-sectional area of the object, and V is the velocity of the object with respect to the air. Spin rate at time t is also considered. The spin rate can be calculated using a decay model using variables including the initial angular velocity of the object, the velocity of the object, air density, cross sectional area, center of gravity, and the inertia of the object. Other variables can also be calculated like the Reynolds number. An industry standard Reynolds Number model is:

$$Re = \frac{ρ VL}{μ} \qquad Equation 10$$

Where ρ is the density of the fluid, V is the velocity of the fluid, L is the length or diameter of the fluid, and μ is the viscosity of the fluid. These calculation can be calculate throughout the trajectory 805 and update the inner areas of the X, Y, Z coordinate system. Once the simulation reaches impact the bottom barrier, the rebound, or roll, can be calculated using variables including, but not limited to, the horizontal landing velocity, the vertical landing velocity, the land angle, and the directional spin rate.

This trajectory physics engine 805 is just an example and should not limit the scope of the invention. The example merely explains how using sensors' 200 data, attached to a garment 100, can calculate critical variables during the trajectory analysis 805 process. Even though there are multiple ways to calculate the trajectory 805 of the object, the inventions scope is using the sensors data 300 to estimate the trajectory 805 using any model or method of trajectory analysis 805 and shouldn't be limited in scope to specific simulation model or method.

The accuracy of the trajectory analysis 805 in real time depends on the impact statistics 804 and the trajectory physics engine 805. The trajectory physics engine 805 estimates variables and coefficients throughout the process, as described above. To reduce the error in the trajectory 805 simulation due to variables estimates, the process back tests all simulated results with actual results 401 when available. Some examples of when the actual results 401 are available include the motion key when a basketball is made, the Global Positioning System (or GPS) location after a golf shot, or playing catch with a baseball. The back testing 1001 begins by defining the amount of deviations 1000 between the actual 401 and simulated results 805. By defining the exact amount of deviations 1000, the machine learning process 1001 can begin to solve for the estimated variables and coefficients. A variation of the machine learning, or back testing process, 1001 tries every possible estimation values, within the given constraints, until the simulated trajectory 805 matches the actual results 401. As more data 300 is available, the machine learning process 1001 begins to make the trajectory 805 simulation more accurate for the given environmental circumstances by limiting the number of false possibilities.

There are three different variations of the machine learning process 1001 which are used to correct the estimated or downloaded variables in the process of predicting the trajectory 805 These variables may include the wind speed, the humidity, the grass height, or any other variables that an estimation has to suffice. The type of process 1001 used is dependent on the type of object and whether the object's trajectory 805 is being predicted until the final resting point or until a “moment of success” occurs. The type of object could be a baseball, basketball, or even said user's body (in the case of snowboarding and gymnastics). The difference between predicting the trajectory 805 until the final resting point and the “moment of success” is apparent when comparing golf and basketball. Once a basketball goes through the basketball goal, the trajectory 805 is irrelevant. On the other hand, a golf balls trajectory 805 is relevant until the final resting position.

The first variation 1001 is implemented when the ergonomic or athletic motion 300 requires predicting the trajectory 805 for the entirety of the objects “momentum”, or until the final resting position. To perform the machine learning system 1001, the invention compares 1000 the actual resting position 401 against the predicted results 805, and, if applicable, implements the machine learning process 1001. The machine learning process is only applicable when the deviations between the actual and predicted results are statistically significant. The 401 actual distance and location from impact can calculated through the IMUs 202, GPS 203 or 204, or anything similar. For example, once the said user completes a golf drive 300 and completes the fairway golf shot 300, the IMU 202 values in between recognized 425 golf shots will measure 600 the exact distance and location of the golf drive 401. The real distance and locational value 401 is then compared to the predicted trajectory 805. If the standard deviation 1000 is in excess, a back test using machine learning 1001 will begin. The machine learning process 1001 solves for the most likely scenario as to why the standard deviations 1000 were significant. The machine learning process 1001 will then update variables deemed responsible for the large deviations 1000 in actual results 401 and the trajectory analysis 805.

The second variation of the machine learning process 1001 is implemented when the ergonomic or athletic motion 300 requires predicting the trajectory 805 until time t, or when the trajectory 805 is either successful or unsuccessful. This method can require a “motion key” 300 to signal to the process if the object was successful 401. For example, every time a said user makes a basketball shot 300 without hitting the rim, a specific “motion key” 300 is implemented. In this example the said user's motion key 300 is pointing to the sky. If the shot 300 hits the backboard first and then is successful, the said user's motion key is swiping his right hand left to right. If the shot 300 hits the rim first and then goes in, the said user points down 300. This allows the process to back test 1000 the trajectory 805 for accuracy and compensate for variables including, but not limited to, the flex of the rim, the atmosphere, the psi of the ball, and the size of the goal.

If the ergonomic or athletic motion 300 requires predicting the trajectory 805 of the said user, e.g. cheerleading or skiing, the sensors 200 will be used to back test the predicted trajectory 805 given the exact amount of muscle fiber activation rates in each muscle, launch angle and another relevant variables for the particular motion 300. In other words, the prediction of the trajectory 805 is instantly back tested against the actual results 401. This process 1001 instantly calibrates the estimated variables for future predictions of the trajectory 805. The process 1001 is similar to the sensor fusion, but provides better insights on what motions the athlete is capable of physically completing. The actual results 401 are subtracted by the estimated results 300. The delta between the two are tested to see if the value is statistically significant. If statistically significant, a machine learning process 1001 solves for errors in the current model, commonly downloaded variables including atmospheric variables 803. By doing this, the trajectory analysis 805 becomes more accurate.

If an optimal motion 708 is desired, the user will be introduced to the ‘Utility Function’ 700. The ‘Utility Function’ 700 allows the user to customize their trajectory 805, or desired results 700, to their specific preferences 700, with respect to the specific athlete's ability 600. Desired results 700 can be defined as a specific result or preferences between different metrics. This is the inventions way to decipher what the user values most and what percent more do they value it. Through this process 700, all historical data 450 is collected and analyzed 701 as a whole with respect to the point of Impact/Release 804. This process runs a regression equation with variables consisting of accuracy, power, risk of injury, and spin (or other categories that are sport specific). It also runs a smoothed quintile model to find the estimated value for each variable at any percentage. These equations are the frame work for the initial toggles. For example, when distance goes up, accuracy goes down to the exact value quantified in the regression equation. This framework 702 is a simple estimation solely for the purpose of said user to understand what each toggle 701 does with respect to the said users desired trajectory 805 or tailored game. The said user can then make an educated decision on their game play preference.

The optimal motion process 708 may use reinforcement learning, or other algorithms that learn (including fields of machine learning, artificial intelligence, deep learning, or similar). The process begins with the collection of the sensors data 300 during motions. This data is analyzed and stored in the data base 400. The motion recognition algorithm 425 sorts the motions 300 into a Sport Specific Biometric Profile 450. The estimated fillers are calculated and the Sport Specific Biometric Profile 450 is completed. Then the optimal motion algorithm 709 then uses cluster analysis to sort all motions 300 into unique sub sections based on key metrics, key features, and/or analytics. The unique sub sections may then be run through more data analytics and sorted into quadrants. The optimal motion algorithm 709 then calculates the probability a motion has to being the optimal motion 708 through probability analysis of each quadrant. At the beginning of the optimal motion algorithm 708 the motion with the best trajectory results already calculated in the SSBP 450 is considered the optimal motion. The probability analysis begins by comparing a motion to the current optimal motion. The process calculates the motions 300 with the highest probability of being a better motion than the optimal motion first. Once a motion has a statistical chance of bettering the current optimal motion, heavy calculations including the equipment 802 variables, the moment of impact 804, and finally the trajectory 805 are calculated. The process' cluster analysis and probability analysis continues to adjust, or learn, from the attributes of successful and unsuccessful optimal motions 708. The optimal motion algorithm may run the trajectory analysis on each motion and compare each motion's trajectory with respect to the optimal motion utility function 700. By comparing the trajectory 805 and the respected metrics of each trajectory 805 the invention has a quantifiable optimal motion 708 based on the users unique body make up and desired results 700.

Another variation of completing the optimal motion algorithm 708 considers using physics and biomechanics to create an optimal motion from the analyzed data of different motions. The optimal motion process 708 begins by analyzing historical data 450 of the said user to predict an optimal motion 708. This data 450 pertains to each relevant ergonomic or athletic motion 300 ever attempted by the said user. By analyzing 600 the data 450, the final product of a customized motion 708 based on the said user's exact body is produced. To produce the customized, or optimal motion 708, the process may calculate two different perspectives of analytics. These perspectives, or statistical models, are coined the “effective ratios” and the “value added ratios”.

“Effective ratios” 600 are the metrics used to help explain how one moving body part effects the other body parts throughout the motion 300. To solve for the effective ratios 600, the invention uses historical data 450 and runs statistical models with respect to each other body part, more specifically each IMU 202. For example, the user's standard deviation, velocity, acceleration, and time until fatigue said user's forearms are completely different if the user's right quad moves left to right than if the right quad moves right to left during the motion 300. These metrics 600 are with the respect to said user's physiological conditions when the motion 300 occurred, such as heart rate, muscle fatigue, lactic acid, and stress levels. These effective ratios 600 quantify the relationship between their moving parts given their physiological scenario.

Based on historical data 450 when attempting an exact motion 300 repeatedly, the invention calculates 600 the said users' analytics for each particular body part, or IMU 202, with respect to the motion's trajectory 805. The process also factors all historically experienced physiological conditions 450, such as the levels of fatigue, the different heart rates, the different levels of lactic acid, and their effect on the motion 300, and in turn the trajectory 805. This calculation is different from the said effective ratios 600. As stated above, the effective ratios 600 calculate a body part's analytics with respect to the other body parts analytics. The value added ratios 600 calculate the analytics of each individual body parts with respect to the trajectory 805. In other words, the value added ratios 600 refers to how each body part's motion 300 will affect the trajectory 805 of the object. An extremely inaccurate body part's motion 300 can consistently affect the trajectory 805 despite the other body part's remaining extremely consistent.

For example, the process 703 selected the right quad's motion 300 with the highest possible velocity. The process 703 simulates how much added velocity 600 that translate to the final impact velocity of the equipment 802, and in turn how much added value the motion 300 adds to the trajectory 805. Given the right quads' historical data 450, the expected standard deviation, average acceleration, average velocity 600 the user can expect a deviation in trajectory 805 of 5 yards in any direction. This deviation 600 was more significant than the average. The process 600 quantifies an expected value added and expect margin of error for all body parts.

The final process 708 uses the analyzed trajectory data 805, the effective ratios 600, the value added ratios 600, and the user's Utility Function 700 to produce a motion 300 that matches the user's desired trajectory 700. The optimal motion process 708 may begin by choosing an IMU 202, such as the IMU 202 on the right quad, and selects the best motion 300 given the effective ratios 600, value added ratios 600, and other key factors inside the parameters 704. The parameters 704 consist of all possible motions 300 which will give the user their desired trajectory 700. The process 704 constricts the parameters for IMUs 202 after each step. For example, if the said user's right leg pivots to the left during a baseball swing 300, the user's upper body parameters 704 would constrict. This constriction of parameters 704 compensates for the reduction in the amount of rotation to right the right shoulder can produce due to the right quads movement. Once the first IMUs 202 motion 300 is optimized 703 and the parameters 704 are constricted, this process 703 is repeated for each IMU 202 until a suggested optimal motion 708 is completed. Each step chooses the best possible motion for the individual IMU based on biomechanics, physics, and metrics from the sensors. Once the first complete motion is completed, this process 703 is also repeated for every possible order of IMUs 202. For example, then first order might be right quad, left quad, chest, left upper arm, left forearm arm, right upper arm, and then the right forearm. The next data mining 703 order will be right quad, chest, left quad, left upper arm, left forearm arm, right upper arm, and then the right forearm. Another order is chest, right quad, left quad, left upper arm, left forearm arm, right upper arm, and then the right forearm. From the list of suggested optimal motions 708, the value added ratios 600 are applied and the object trajectory 805 is predicted given the law of large numbers. The best possible motion 707 is archived 450 and displayed 900 as the optimal motion 708.

Another variation of this process 708 uses the value added ratios 600 in the data mining process 703. This process 703 differs due to the fact that the value added ratios 600 are not the decider between suggested optimal motions 708, but are used in the data mining process 703. This process 703 uses the effective ratios 600 to set parameters 704 and give insight of which motion 300 is better when considering the other IMUS 202. The value added ratios 600 are used to maintain the desired results 700 throughout the process 703 and give insight of which motion 300 is better when considering the trajectory 805. In other words, the value added ratios 600 gives focus to the process 703 and is used to confirm the desired results 700 will be attained. For example, the user's right quad has a large standard deviations 600 with respect to the effective ratios, meaning other body parts are extremely correlated with the consistency of that particular motion 300. This statistic 600, combined with a large standard deviation when considering the value added ratios 600, can lead to significant trajectory deviations 805. But that motion 300 also gives the best possible results 707 with respect to distance. This process 708 then compares this motions statistical probability of maintaining the desired trajectory 700 consistently over time with another motion 300 that has a low standard deviation effective ratio 600 but also has a higher value added ratios 600. By the end of comparing each IMU 202 motion with other motions from the same IMU 202 and with the other IMU 202 values, an optimal motion 708 with at least the values of the Utility Function 700 is produced. If multiple motions 705 produce similar results, the user's preference 700 on which analytics are valued the most is the determinant. For example, 10 suggested motions 705 have the statistics 700 the said user desires. One has a much higher expected accuracy 805 while the other has a much higher expected distance 805, and the user values distance over accuracy 700. The suggested optimal motion 708 with the higher expected distance 805 will be archived 705 and displayed 900 on the preferred device 204.

The invention claims the ability to use the trajectory analysis 805 of each motion 300 to sort through to find a statistically significant optimal motion 708 given the users Utility Function 700. By using the data from the sensors 200, the process is able to simulate the equipment 802, moment of impact 804, and the trajectory 805 as shown above. In a variation the optimal motion 708 is calculated by combining historical motions 450 together and estimating the motions metrics. The optimal motion process 708 also uses the archived database 450 with or without simulated data, to provide the necessary possibilities of motions in other variations. But by combining a trajectory analysis 805 with each motion, or only statistically significant motions 300, the invention is able solve for which motion 300 is better and produce statistics that prove why that motion 300 is better.

All variations are back tested 1001 and some motions might not maintain their statistics 701 in the real long run. If another suggested optimal motion's 708 trajectory 805 is statistical significant when compared 1000 with the actual motion 401, the suggested optimal motion 708 will be displayed 900 to the user.

The invention may use a visual approach 900 to demonstrate the optimal motion 708. The visual approach uses kinematics of rigid body to show the motion 300 and analytics through a 3D avatar 900. Each body parts motion 709, which was selected through its analytics 701, is displayed 900 via the exact IMU 202 values at its respective time. By inserting each IMUs 202 values in the avatars 900 exact location with respect to time t, the avatar 900 produces an exact digital replica of its optimal motion 708. The optimal muscle fiber activation rates 709 are then added to the avatar 900 with respect to time t. This data is collected from the same location 709 in which the IMUS 202 data was collected. This shows the optimal amount of flex for each muscle throughout the motion 708. It is displayed 900 through the avatars 900 muscles, which are located in the respective locations, and gets darker when more muscle fiber activation occurs. As to say, the lighter colored muscles need less muscle fiber activation than the darker colored muscles.

After each attempt 300 of the optimal motion 708, biofeedback 710 is displayed 900 in three variations. Biofeedback 710 compares the previous real time motion 300 with the optimal motion 709. If any deviations are present, the biofeedback algorithm 710 calculates how each body segment affected the trajectory 805 of the real time motion 300. For example, the value added ratios 600 determined the user's trajectory 805 is directly affected by the right quads motion 300 by 10 yards southwest. So to say, the deviations 701 of the right quad was solely responsible for such quantified value of the trajectory 805. If the right quad was directly consistent with the optimal motion, the trajectory 805 would be normalized and the 10 yard southwest deviation 701 would not have occurred.

One variation of the biofeedback 710 display 900 is through a qualitative display 900. The qualitative display 900 gives insight pertaining to the comparison of the actual motion 300 and the optimal motion 709. The biofeedback process 710 continues by calculating the effective 600 and value added ratios 600 for each body part. After the actual motion 401, the qualitative display 900 will choose the body part with the highest correlation to the deviation 701 of the trajectory 805 and give instructions like “Right quad was too far to the right at impact”. The graphical interface 900 allows the user to adjust given the qualitative instructions.

The second variation is through a vocal announcement 900. The vocal announcement 900, will calculate the body part with the highest correlation to the deviation 701 of the trajectory 805. This variation 900 will announce instructions through the preferred device's 204 speaker (e.g. “Right quad was too far to the right at impact”).

The third variation is the visual comparison biofeedback 710. It will transparently overlay the real time motion 300 with the optimal motion 709. This shows not only the most significant deviation from the optimal motion 709, but every other deviation from the motion 300. It allows for more advanced adjustments and demonstrations. This method collects the data 300 from the sensors 200 and displays 900 them through a kinematic of rigid body avatar 900, similar to the optimal motion 708 display 900. The difference between the optimal motion 708 display 900 and the actual motion 300 display 900 is the collection of the data. Instead of using data from different optimal motion archive storage 709, the data displayed is from the most recent recognized motion 300.

If the said user is unable to obtain the necessary analytics 600 for their desired results 700, or trajectory 805, the invention has the ability to give a workout program and diet tailored to the said user's body makeup. The Optimal Workout Algorithm 750 begins by making the sensors data for each motion a range in the Sport Specific Biometric Profile-Future Results 450. Sport Specific Biometric Profile-Future Results 450 begins as a copy of the Sport Specific Biometric Profile 450. The SEMG 201 values for each muscle and its respective PCSA become variables with constraints. The constraints are given through realistic expected future SEMG 201 values for each muscle and PCSA. These constraints have their own algorithm, but is based on the users' body response and the science between reduction in fatigue levels, muscle hypertrophy, and others. By making the maximum SEMG 201 values a variable and adjusting metrics including time until fatigue, the future results sport specific database 450 is updated. The sensor fusion algorithm then updates the IMU 202 values based on the new SEMG 201 variables for increases in velocity, reduction in standard deviations of the motion 300, and other values and metrics. The new Sport Specific Biometric Profile-Future Results 450 is stored and archived.

The new Sport Specific Biometric Profile 450 is then used to calculate the future optimal motion 708 (coined future optimal motion 708 because the expected SEMG 201 values are purely theoretical at this time). The future optimal motion process is calculated the same way as the optimal motion 708, which is described above, and uses the new database to calculate the trajectory 805 of each motion 450. Once the future optimal motion 708 is solved for, the motion, values, and metrics are stored 709. The Optimal Workout process 750 then finds the delta values and metrics between the current users' body capabilities and the desired body capabilities. Once the process knows exactly how much change needs to occur in each muscle and its respective PCSA, a database containing all known single workouts (or individual motions that are completed to increase the values and metrics) is searched. The Optimal Workout 750 search process aims to find workouts that target the areas of needed improvement and create a combination of workouts that have added value. The added value can be calculated using a multivariate regression model, a reinforcement model, or anything similar in scope. The process considers fatigue levels, latic acid values, and many other variables in the process and tailors the workout for the optimal results of the user.

In another variation of the optimal workout algorithm 750, user inputs decide the delta values and metrics between the current users' physical body and capabilities and the desired physical body and capabilities. This variation can be in combination with the Optimal Workout 750 variations above. Meaning, the user can choose to input desired results 700 and use the optimal motion 708 approach to the Optimal Workout process 750 to find the delta values and metrics. The user input variation includes, but is not limited to, values like a reduction in fat mass in specific body parts, an increase in muscle mass in specific body parts, increased velocity in specific body parts, increased muscle torque (or muscle strength) in specific body parts, increased velocity in specific body parts, and a reduction in deviation in motions 300. For example, if the user wants to increase muscle torque in the biceps brachii by X amount, the process estimates the amount of muscle hypertrophy required to produce this amount. The correlation between the amount of muscle hypertrophy and amount of added torque in the muscle can be calculated through numerous different models. One model correlates the amount of fast and slow twitch muscle fibers with the current amount of torque. By assuming a linear correlation between the muscle fibers and amount of torque, an estimated amount of added muscle hypertrophy is needed to achieve the desired amount of torque. Other, more advanced, models can be completed for a more accurate reflection of the amount of muscle hypertrophy required to achieve the amount of torque desired in the biceps brachii. The models can continually update over time to give a better reflection of the exact amount of muscle hypertrophy required. Once the delta values and metrics are calculated, the process searches the database (described above) to find the optimal combination of workouts to achieve the goals of the user.

Another embodiment of the Optimal Workout process 750 may use the effective ratios 600 and value added ratios 600 as a baseline through these simulations, since each user's athletic ability 600 for different motions 450 is different. The process may then use the said user's historical body's response 450 to specific workouts and diets and formulates the perfect training regimen for that particular user. For example, the athletes value added standard deviation 600 for the right quad increases by 75% when under fatigue 600. The process then correlates previous workouts and a database of workouts with the reduction of fatigue 600. For example, the users' “Barbell Squat” is more statistical significant than the “Leg Press” for the purpose of reducing fatigue with respect to the optimal motion 709. The process finally couples the squat with a series of workouts that compliment it for the best possible results.

This process can also be used to learn how to lose fat mass or gain muscle mass independent of the specific ergonomic or sports motion 708. The body fat mass is collected 300 through the signal distortion levels of the SEMG 201, or consumer entered values of body fat mass for each body part. The inventions process for losing body fat mass and optimizing a diet is similar to the process stated above. The user can only complete the Optimal Workout Utility Function 700 and not complete the Optimal Motion Utility Function 700. By selecting this process, the Optimal Workout Algorithm 750 only focuses on the Optimal Workout Utility Function 700 (including specific results including specific increased metrics, increased muscle mass, or decrease fat mass). The Optimal Workout Algorithm 750 searches the database for motions that will produce the desired results. One difference in this process is the simulation of the trajectory 805 is unnecessary.

The optimal diet is a list of food categories that gives the user the desired amount of nutritional values for achieving the desired goal. If the goal is simply fat mass, or weight, reduction the optimal diet will produce a list of food items to achieve this weight loss, with respect to the amount of activity the user achieves. The list can be general, or it can be meal specific. It can, for example, produce a specific meal plan for the user when considering breakfast, lunch and dinner. It can also be set based on a prepared “training table” diet. The display 900 can also be set based on eating out and based on specific types of food genre. Because the process collects data 300 during specific activity related training, strength, and endurance related workouts, the diet can be updated after every workout 450. It can also be updated to remain optimal in the long run every time the user eats. It also offers recommendations for the user, given their previous food preferences and required nutrition. If the user over eats the program will automatically provide information about how to compensate for the added nutrition during the next workout or meal, or change workouts to compensate for the added nutrition.

The visual altering process also uses the combination of data 450 from the Optimal Workout 750 and optimal diet. This is the process where the user can visually 900 view their simulated change in body mass that will occur in the future, briefly mentioned above. The invention simulates how the body will visually change in the future, if the workout program and diet are followed. For example, if the desired goal of the user is to lose 30 pounds in a year, the proper workout and diet regime is produced. The visual altering process allows the user to see how their body will change at any time in the future. They can run the simulation for 1 month, 5 months, 9 months, or even their ‘end product’ at the end of the year. The process is completed by the estimated effects of the workout and diet plan. More specifically the delta, or change, of muscle hypertrophy and the delta, or change, in fat mass. To collect the delta fat mass at any particular time in the future, it compares the delta calories of the workout and diet. To collect the delta muscle mass, the process uses a statistical model that predicts muscle fiber increase given historical data 450. The process uses the common knowledge of the exact amount of liters in each pound of fat mass and pound of muscle mass to visually 900 show the user's body changes in the future. This process continues to update when a change in workout or diet occurs.

The process also allows the user to determine the best possible equipment 802 for their tailored game. To simulate which equipment 802 is best for the end user, the invention allows the sports equipment 802 constants, to become a variable. The process then maximizes the sports equipment 802 variables to produce the best end results 805, with respect to the users' optimal motion 709 and Utility Function 700. Once the equipment values 802 are maximized, it then searches a list of sports equipment 802 that are similar to the maximized sports specific variables 802. For example, for a golfer, the such maximized sport specific variables 802 considered include, but is not limited to, the club head mass, the shaft stiffness, the shaft length, the golf ball, and other variables. It also runs analytics on such variables including the club head speed and the club head lead lag given the users motion.

In another variation of optimizing the sports equipment 802, the process uses a database of all sports equipment 802 variables and equations to decipher the best motion. Discussed above, before the equipment 802 can be simulated, the user input is used to search a database of equipment 802 to use the appropriate variables and equations for the specific equipment 802. This variation of optimizing the sports equipment uses all the equipment specific variables and equations 802 during a motion or during the optimal motion process 708 to quantify the deviations between the equipment 802. The metrics and suggestion of optimal equipment 802 will be displayed 900 to the user via their preferred device 204.

For example, if the user wants to keep their motion 709 the same but better their results through new equipment 802, the user instructs the invention to run a simulation of all known equipment 802. In golf, the simulation will include every combination of gloves, grips, shafts, club heads, and golf balls. This simulation uses a law of large number statistical approach when considering the expected deviations of the users' motion 709. The invention uses the users' Utility Function 700 to rank each combination of equipment 802 and displays 900 their results. The results include the rank and the performance testing results and is displayed on the users preferred device 204. This process is similar to the Optimal Workout Algorithm 750 making the MAUP and metrics variables.

Another variation is using archived data 450 for the purpose of coaching another individual through an avatar 900. This process allows one user to complete a motion, a trick, an athletic motion, an ergonomic motion, a training regimen, or such, and archive the data 450. That data 450 is then displayed 900 on another users preferred method 205 to be recreated. The data 450 is displayed 900 the same way as an optimal motion 708 is display 900. The difference is the data is collected from the archive 450 and not through the optimal motion process 708. The final end user can attempt to recreate the motion and one of three biofeedback 710 variations will display 900 inconsistency from the initial user and the end users motion 300.

Another variation is using the archived data 450 to program a robotics unit. This variation uses data collected 450 from individuals, who agree to participate in the process, to program a specific ergonomic motion 300 to a robotics unit. Similar to the display 900 of an optimal motion 708, a motion 300 that has been optimized 709 is archived 450. This includes the exact IMU 202 values and all analytics 600 retaining to the motion 300. These analytics 600 include, but are not limited to, the amount of force through-out the motion, the amount of angular acceleration through-out the motion, and the amount of velocity throughout the motion 300 of each body part. Instead of displaying 900 all this data 600 into an avatar 900, as explained above, the analyzed data 600 is sent to a robotics unit to be recreated 300. The robotics unit will process the data and replicate the optimal motion 708 according to the data. This process is using “donated” ergonomic motions 300 for the purpose of teaching a robotics unit the exact X, Y, Z at time t for each body part, the equivalent of the exact muscle flex 300 (the amount of grip or pressure applied throughout the motion 300), and all analytics 600 pertaining to. Depending on the way the robot operates, these steps could include given direct instructions to the robotics actuator, or such.

In other variations of the biometric system 200, respiration sensors, galvanic skin response sensors, temperature sensors, global positioning system sensors, vibration sensors, bio impedance sensors, bend-angle measurement sensors, light detection and ranging (LIDAR), and any other sensors relevant for the data collection process. Another variation of the biometric system 200 includes added any of the previous listed sensors 200 to a user's equipment coupled with the garment 100.

In other variations of the biometric system 200, added or removed sensors 200 are included on the user. This includes more or less SEMG 201, IMU 202, EKG 201 sensors 200 then what is described in FIG. 6, FIG. 7, FIG. 8, FIG. 9, FIG. 10, and FIG. 11. The exact amount of sensors 200 or their location attached to the clothing 100 is not limited in this patent, but the ability to use the sensors 200, specifically IMU 202 and electrodes 201 (more specifically SEMG and EKG), attached to the clothing 100 or garment 100 to predict the trajectory 805 of an object is included in the scope. In other variations, the invention can include a short sleeve compression shirt instead of a long sleeve compression shirt. The invention loses ability to calculate the hands motion 300, but can still predict trajectory 805 monitor the optimal motion 708, and monitor the Optimal Workout 750 with a degree of certainty.

In other variations of the biometric system 200, added sensors not attached to the clothing 100 are used in the calculation of the trajectory analysis 805. For example, a glove not attached to the garment 100 that has sensors can be used in the trajectory analysis 805, optimal motion process 708, Optimal Workout process 750, optimal diet, or optimal equipment, or such described above. The added sensors data complements the garment's 100 sensors data, but does not change the ability of the garment's 100 sensors 200 to solve for the variables.

Another variation of the IMU sensors 202 calibration uses key motions. This variation uses the said motion key to calibrate the IMUs 202 when attached to the garment 100. This motion key is customizable to the user's preference, but a suggested motion key is given. The motion key's motion 300, when recognized or instructed, is compared to the Kalman Filter's results. If the delta between the two are significant, the appropriate data in the Kalman filter or such is calibrate. For example, by touching the IMUs 202 on the right arm and chest in a sequence, the left arm's IMUs 202 will calibrate for any deviations at all. The SEMG 201 values 201 of the left arm will confirm the exact time when the user touches the location for the calibration process through abnormalities in the SEMG data.

Once any data 300 is collected, the data is stored 400 and archived 450. This data includes all biometric sensors 200 in use during every motion 300. It also includes the any relevant analytics through any of the inventions processes, including the data mining 500, data session 600, optimal motion 708, trajectory analysis 805, graphical user interface 900, system clients 950, and machine learning 1001.

Information collected 300 and analyzed 600 through the inventions process may be archived 450. The archival storage system 450 may be in contact with the preferred device 204 or may be archived 450 on the preferred device 204. The archived data 450 can be retrieved for data mining 500, data sessions 600, research, nueroeconomics, equipment modification 802, programming a robotics unit, or such, but only under the direct consent of the said user.

The present invention is well adapted to carry out the objectives and attain both the ends and the advantages mentioned, as well as other benefits inherent therein. While the present invention has been depicted, described, and is defined by reference to particular embodiments of the invention, such reference does not imply a limitation to the invention, and no such limitation is to be inferred. The depicted and described embodiments of the invention are exemplary only, and are not exhaustive of the scope of the invention. Consequently, the present invention is intended to be limited only be the spirit and scope of the claims, giving full cognizance to equivalents in all respects.

### Detailed Example of Invention of Real Time Example of Trajectory Analysis

The invention claims the ability to take the input of sensor data 300 on an athlete and turn that data into a trajectory 805 of an object.

This detailed example of the invention considers an athlete, whose wearing the garment 100 with the sensors 200, throughout a golf swing 300. A golf swing 300 is used because it is one of the more complex sports motions, and driving the ball is used as opposed to other golf shots, because it involves the full application of force on the ball. The golfer wears the long compression pants 100 and long sleeve compression shirt 100, but with integrated sensors 200.

The golfer addresses the ball. In the typical golf stance the golfer stands with his [or her, but his is used throughout] feet spaced roughly shoulder width apart and with the toes on a line that roughly parallels the intended line of flight of the ball. The golfer (who in this example is right handed) holds the golf club 802 (in this example a driver) with his left hand at or near the end of the grip and with the right hand placed on the grip just below the left hand. There are a number of different common golf grips, and the data collected and analyzed in this method will help the golfer determine which grip is most appropriate for his body type and relative golf experience. In a typical golf stance the golfer stands with feet about shoulder width apart, knees slightly bent, butt pushed back slightly, with the back straight and angled forward. The club is typically in a straight line with the left arm from the left shoulder down to the ball. The right arm is angled to hold the club so that the arms form a “Y” shape.

During the swing the golfer pulls the club back along a line and then rotates the wrists so that the wrists become a hinge for the rotation of the club. This movement causes the IMU 202, more specifically the accelerometers and gyroscopes, to respond to the dynamic movements. The values correspond and correlate these responses, from the accelerometer and gyroscope, to the movement is considered raw data. The raw data needs to be analyzed through an algorithm to provide less noisy and more reliable data. As stated above, raw data can be analyzed 300 by many different models, but in this example a custom smoothed model is used.

Once the data 300 is transformed from the raw data state, it is consider analyzed data. The analyzed data 300 is used for the rest of the calculations and is referred to as the data for the rest of this example.

With the analyzed data 300 stored in memory 400, inferences about the motion 300 can be made. In this example, a value recorded from the gyroscope on the right forearm would infer the user has begun to move into his backswing 300. It would also infer the users' speed of rotation around the x, y, and z axis. A value recorded from the accelerometer on the right forearm would also infer the user has begun to move into his backswing 300. Unlike the gyroscope, the accelerometer will measure the velocity of the motion 300 around the x, y, and z axis.

Continuing with the right forearm at the beginning of his backswing 300, traditional sensor fusion of the data transforms the accelerometer data, the gyroscope data, and the magnetometer data into more reliable results as described above. A Kalman filter contains two different phases. The first phase predicts the system state in the future, and the second phase compares the predicted state with the real data. Factors including estimated noise and errors in the system and measurements are included in the comparison. The final state estimation is outputted. The output is used for phase one time 2. This example uses a custom Kalman filter that uses the IMUs 202, SEMG 201, biomechanics, and physics in phase one. This provides a more accurate reading and less drift.

When you combine the analyzed data of the IMUs 202, or accelerometer, gyroscope, and magnetometer, and SEMGs 201, it is possible to calculate the position and orientation of the body segment the IMU 202 is attached. Certain assumptions are required, like the body segment is a rigid body, to find the position and orientation of the entire body.

After the sensor fusion, the orientation may be defined by a quaternion differential equation. The orientation and position may also be calculated in a variety of different methods including, probabilistic models, machine learning, and artificial intelligence models. The position and orientation calculations are then inputted into a kinematics model, or such, to create the full body motion.

As described above, the body segments are assumed to be rigid bodies. The right wrist of the athlete cannot be considered part of the right forearms body segment because the wrist can rotate. Since there aren't any sensors 200 on the wrist, the wrist and fingers' orientation has to be estimated. This estimation is calculated through a machine learning model. The machine learning model was trained prior to the golf swing 300. The model calculates the hand position by the combination of the IMUs 202 and the muscle fiber activation rate in key areas including the forearm. The forearm SEMGs 201 uses the motion recognition algorithm 425 to decipher the location and path of the fingers and wrist. These muscles are called extrinsic hand muscles, or more specifically include, but are not limited to, the Flexor Carpi Ulnaris, Palmaris Longus, Flexor Carpi Radialis, Pronator Teres, Flexor Digitorum Superficialis, Flexor Digitorum Profundus, Flexor Pollicis Longus, Pronator quadratus, Aconeus, Brachioradialis, Extensor Carpi Radialis Longus and Brevis, Extensor Digitorum, Extensor Digiti Minimi, and Extensor Carpi Ulnaris. The abduction, adduction, extension, and flexion movements of the muscles are used to calculate the location of the wrist and fingers through the motion recognition algorithm 425. The training data for the individual is a simple test, which occurs usually at the beginning of collected data, or first time the garment 100 is being worn and data is collected through the sensors 200. For the hand example, the user will be asked to complete a series of finger and wrist motions which will be used to estimate the real time motions, or train the motion recognition algorithm 425. Once trained, the software is able to use similarities in the training data and the real time data to determine the wrist and finger locations. Once the position and orientation is estimated, metrics can be calculated. This process can also be completed for other body parts including the feet.

This detail example uses a 3D Cartesian Mesh, which is 3D space composed of cubes. These cubes are aligned with the Cartesian coordinate axis and allow for calculations in the 3D area. The 3D Cartesian Mesh is used for calculations and displaying purposes.

After all previous calculations, the data is plotted in to the Cartesian mesh. The values to be plotted, among all other calculations, are archived 450 for future use. By continually updating the analyzed data, the avatar 900 inside the Cartesian mesh displays the motion 300 in real time. The avatar 900 follows restrictions including those from sensor fusion, biomechanics, physics, and others specific to the Cartesian mesh.

A simple motion recognition algorithm 425 is implemented. The motion recognition algorithm 425 uses multiple motions 300 as a framework for the algorithm. Meaning a user will complete and label different golf swings 300. The IMU 202 values of the golf swings 300 are archived 450 and a large standard deviation is applied to those values. This builds the frame work for an archived motion recognition process, or range of motions considered a golf swing 300. The IMU 202 ranges, or IMU 202 values with the large standard deviation applied, are used to recognize a motion 300. More specifically, the IMU 202 ranges, with respect to time t, create a data set, or parameters, to test every motion 300 against. For example, a golf swing 300 has key attributes each IMU 202 will follow. The golf swing 300 will deviate throughout the round and will completely change over time, but the overall key attributes of the golfers swing 300 will always be recognizable through the IMU 202 ranges. When a motion 300 is recognized, the archived data 450 will be labeled for future data retrieval.

Archived values 450 are used to calculate net dynamic forces on equipment 802. In this detailed example, the motion 300 is recognized as a golf swing. The software automatically solves for the dynamic forces on a golf club 802. In this example, the user's hands are responsible for the dynamic forces on the golf club 802. The rest of the user's body motions 300, each body segment's movements, affect the hands movement, path, and metrics.

Net force is the sum of all directional forces at each specific location. For example, the net force for the right upper arm is the sum of the dynamic forces, aerodynamics (air resistance), gravity, and other factors that affect the motion 300. Each individual force acting on the right upper arm at time t is summed to a net directional force. The net directional force provides a value and a 3D direction that each body segment is producing at time t.

The same calculations for net directional force with respect to each body segment is applied to the equipment 802, or in this detailed example the golf club 802. Similarly to the net directional force with respect to each body segment, the net directional force for each segment in the golf club 802 is calculated by summing all forces acting on the golf club 802. The dynamic force produced from the hands of the user (or in turn from the entire body of the user) effects each segment of the golf club 802 at time t. These effects produce different amount of force for each segment on the golf club 802. The dynamic force acting on each segment is combined with all other forces acting on each segment of the golf club 802 at time t to produce the net directional force on each segment of the golf club 802 at time t. Other forces include, but is not limited to, the aerodynamics of the golf club's individual segment, the elasticity of the golf club, gravity, and the active response one segment of the golf club 802 has on another segment of the golf club 802.

This process of measuring net forces from the user and using those calculations to estimate the net forces on each segment of the golf club 802 is not inclusive to net directional force. Other key metrics that use this process include, but is not limited to, angular velocity and velocity.

The golf club's 802 axial deformation, the bending in the two transverse directions, and the angle of twist around the centroidal axis at time t are calculated. This example assumes the golf shaft is a Rayleigh Beam. By making the assumption the golf shaft 802 is a Rayleigh Beam, calculations for each body segment of the golf club 802 can be calculated. Calculations including, but not limited to, the amount of resistance, the amount of flex, and amount each body segment affects the other body segments. These calculations use the metrics including, but not limited to, the net directional force, net directional velocity, net directional angular velocity, the gravitational force, the internal elastic forces, which are described above.

As the swing 300 continues from t₁, typically the arms are brought back until the left arm is roughly parallel with the ground. This will cause the golfers shoulders to rotate around the hips, the hips to rotate slightly, and the legs to move slightly, with the right left straightening slightly and the left knee bending and rotating slightly to the right. When the golfer begins the downswing 300 to strike the ball the tension in the body releases which helps speed up the centrifugal motion 300 of the head of the club. Typically, also, the wrists are hinged so that the unhinging of the wrists creates a snap like twisting of the club to further increase club head speed. The embedded sensors 200 (specifically the IMUs 202) in the pants and shirt 100 continue to measure and record the precise position location of each body part during the golf swing 300 and simulate the golf club 802. These measurements, explained above, continue through the entirety of the swing 300; from when the golfer address the ball, through the back swing 300, through the downswing 300, the hit, and through the follow through.

While the golfer is swinging 300 the club, the data 300 is continuing the computations 600. The software's next step is to find when impact occurs. The sensors data 300, more specifically abnormalities in the data, is the way the software finds the impact time in this example. When the golfer makes contact with the ball, the impact causes vibration in the club called modes. These values can be recognized through the sensors 200 and is considered an abnormality. Another abnormality the software looks for is the reduction in velocity in the sensors 200. It is possible to calculate the COR, or coefficient of restitution, through the sensors 200 and is consider an abnormality that indicates time of impact.

Throughout the motion 300, the software assumes the golf ball is slightly in front of the club 802 at set up. With that assumption, the phantom object 802 (or golf ball) has an initial x, y, and z location inside the 3D coordinate system determined from to or t₋₁ of the golf swing 300. When the simulated equipment's 802 (or golf club 802) x, y, and z location meets the x, y, and z location of the phantom object 802 (or golf ball), the impact statistics 804 calculations may begin. Other tricks of the trade include measuring impact related metrics including, but not limited to, coefficient of restitution, recoil, and frequencies to back test the estimated golf ball x, y, z location. The correlation between the specific patterns in metrics may demonstrate contact with the golf ball has occurred. If the initial contact location does not match the specific patterns of the metrics, the estimated location of the golf ball may be relocated to the location determined from the metrics. These tricks of trade may also decipher the type of contact (center, toe, ect).

Once impact time and location is determined, the 3D coordinate system is used to calculate the impact statistics 804. The impact values, metrics, and statistics 804, including, but not limited to, the launch angle, impact velocity, launch angular velocity, launch friction, coefficient of restitution, are calculated by the simulated club head meets the golf balls x, y, z location, known as the “location impact”. Once the location impact has been determined, a time stamp is archived. Some values, metrics, and statistics are calculated through a time frame where t_{impact} is included in the time frame. Some values, metrics, and statistics are calculated through the sensors' data 300 and simulations from the sensors' data 300. The velocity of the golf club 802 can be calculated by an industry standard equation

\vec{v}(t)=x′(t)î+y′(t)ĵ+z′(t)\hat{k} Equation 12

The acceleration of the golf club 802 can be calculated by an industry standard equation

\vec{d}(t)=x″(t)î+y″(t)ĵ+z″(t)\hat{k} Equation 13

The speed of the golf club 802 can be calculated by an industry standard equation

∥\vec{v}(t)∥={square root over ((x′(t))²+(y′(t))²+(x′(t))²)} Equation 14

The launch angle is a multistep equation that includes knowing which golf club 802 is being used and the simulation of the golf club shaft 802. The degree of loft in the club at impact and the path the golf club 802 takes through the ball is then used to calculate the launch angle. The amount of spin, or angular velocity of the golf ball, is calculated using the same assumptions. To accurately calculate the directional rpm's of the golf at impact, a simulation of a golf ball at impact may be implemented. The simulation of the golf ball factors in the elasticity of the golf ball and how the golf ball responds to an impact. This example does not use this simulation but estimates the angular velocity of the golf ball through the loft of the golf club 802, the path of impact, and the location on the club face the impact occurs.

The impact values are then sent to the trajectory physics engine 805. The trajectory physics engine 805 uses the initial launch values, metrics, and statistics to determine the initial flight of the golf ball. The remainder of the flight is determined through the values and equations acting on the golf ball. The trajectory physics engine 805 may use the 3D Cartesian Mesh described above, but may also be a series of mathematical equations. In this example a combination of 3D Cartesian Mesh and mathematical equations is used. Once the physics engine recognizes new values are present, the trajectory physics engine 805 calculates the golf balls flight. In other words, the golf ball will have values and equations assigned to it which will cause the ball to go from a stationary position to an active position in direct correlation with the key inputs.

The ball flight is then affected by forces including, but not limited to, aerodynamics, lift, drag, gravitational force, speed of the ball, linear acceleration, angular acceleration, landing velocity (vertical, horizontal, and depth), rebound velocity (or bounce), friction of ground impact, coefficient of restitution at rebound, wind, humidity, temperature, and the atmospheric pressures. Some values may be estimated or downloaded from a database. These values and equations form the values and equations in the inner areas of the 3D Cartesian Mesh.

The Cartesian mesh, as described above, is a virtual 3D coordinate system aligned with the Cartesian axis that has multiple inner cubes. Each inner cube has different equations or values that will affect the ball. These equations or values represent any and all forces acting on the golf ball throughout the fight. This allows for a more accurate ball flight simulation. The simulated ball passes through inner areas and the simulated ball's flight is affected differently depending to the specific inner area's equations and values. The equations and values in each inner area can differ from vertical height, horizontal height, or for any reason deemed to make the simulation of the golf ball more accurate.

The golf ball is considered an object and information pertaining to the location at any time t and any other relevant information throughout the flight of the golf ball is stored for real time and future analysis. The real time analysis includes, but not limited to, the apex, speed, acceleration, and velocity. The apex is determined when the x value begins to descend. The software instructs the software to display the apex whenever the delta x values is positive. The velocity, acceleration, and speed can be calculated by the industry standard equations.

A feature the trajectory analysis 805 includes is a stop function. The instructions from the processor to stop simulation after the simulated ball has a velocity, or other key metrics, of 0 for a period of time after velocity has reached at least 1. This feature stops the inner areas from continually updating when deemed unnecessary. The velocity can be calculated in numerous different ways, but this example collects the data from the simulated ball with respect to the Cartesian mesh coordinates. The data, more specifically the coordinates, from the simulated ball is archived with a timestamp in the server 205, or such. The coordinates and timestamp are used to calculate the velocity at any time t of the simulated ball, or any object inside the Cartesian Mesh. By adding the stop feature, unnecessary computations are avoided.

As described above, the balls x, y, and z location is archived 450 throughout the flight and roll of the ball. The archived values are used to calculate metrics about the flight including distance, location, degree of flight deviation (e.g. amount and degree hook and fade), vertical flight pattern, and others that are relevant to the user. These metrics are then archived 450 with the other relevant archived data, including the balls x, y, and z location with respect to time t.

The ball flight data, the ball flight metrics, and other information that is deemed relevant by the user is sent to the users preferred device 204 to be displayed. The information may or may not be displayed in a 3D ball flight format or a data sheet format. The data may be continuously (or in optimal packets) sent to the preferred device 204 to be displayed 900.

The software may back test any estimates with real locational data from GPS or other sources 401. If the real location 401 is not within the expected range provided from the simulation, adjustments to values or equations may occur. The expected range provided from the simulation is defined as the specific location estimated from the trajectory analysis 805 with a diameter of multiple standard deviations applied to it. This process mainly focuses on the inner areas and downloaded information that is generic in nature, like the humidity, but can be applied with any value or equation.

This example shows how the golfer, wearing the garment 100 with sensors 200, completes a swing 300. The swing 300 activates the sensors 200 and creates raw data. The raw data of this invention is considered an input. This example shows how the input data is put through multiple algorithms, physics engines, and others to produce a trajectory 805 of the golf ball. The trajectory 805 is considered the output. The scope should not be limited by specific equations, algorithms, or specific objects. The scope should include the such claimed ability to take an input of raw data and transform it into the trajectory 805 of an object and analytics pertaining the trajectory 805.

### Detailed Example of Using Trajectory for Producing an Optimal Motion

As described above, the athlete completes a motion 300 and the raw data is turned into analyzed data. The analyzed data is turned into a motion 300. The motion recognition software 425 completed is implemented for each motion 300. This allows the software to archive a motion 300 in a specific SSBP 450 database instead of the normal BP 450. This process continues throughout the entirety of the user wearing the garment 100.

Metrics including, but not limited to, time until fatigue, deviations with respect to the amount of fatigue, average muscle fiber activation rates, average velocity, average speed, average deviations from normal, and average heart rate are calculated 600. These metrics are all calculated differently, but for example time until fatigue averages the amount of time (from the timestamp) until fast twitch muscle fiber become dormant. These calculations can be calculated for any amount of fatigue. The amount of deviations with respect to the amount of fatigue is calculated by running statistical analysis on multiple motions 300 under specific amount of fatigue levels. The statistical analysis may be compared to the baseline, or the statistical analysis when fatigue is not present (average or expected amount of deviations). Average muscle fiber activation rates is simply the average of each PCSA SEMG 201 readings.

The raw data, analyzed data 300, motion metrics 600, trajectory data 805, trajectory metrics 805, and all other relevant data is archived in a server 205 or anything similar in nature. Since the motion recognition software 425 recognized the motion 300 as a golf swing 300 the server 205 may or may not store them in a database of all motions 300 (known as the Biometric Profile 450, or BP 450) and/or a specific database only for golf swings 300 (known as the Sport Specific Biometric Profile 450, or SSBP 450). For instance, the SSBP 450 contains every golf swing 300 and its respective relevant data 300 ever completed while the user wears the said garment 100.

The invention then estimates all data values that have not yet been collected through the garment 100 technology, or holes in the SSBP 450. The invention refers to this particular data as filler data. Many approaches can be used to estimate this data including, but not limited to, probability analysis, weighted statistical analysis given the real data, a GAN model, a GAN inspired artificial intelligence model, reinforcement learning, any combination of said models, or others. For this example a weighted statistical analysis model and probability analysis model is described, but the patent should not limit the scope of how the filler data is calculated.

The filler data is calculated by using the real data stored in either the Sport Specific Biometric Profile 450 or the Biometric Profile 450. For this example the Sport Specific Biometric Profile 450 is used due to the shear fact that less filler data is required and the process of optimizing a sport specific motion 300 doesn't require every possible combination of body parts' motions 300 to achieve the goal of this algorithm.

The filler data is estimated by assigning weights to historical motions data inside the SSBP 450 according to probability analysis of like motions. The process' probability analysis quantifies how similar a historical motion is to an individual filler data motion and the statistical chance that a historical motion would share similar characteristics (MAUP values, metrics) as an individual filler data motion. The process considers similar body segment motions, multiple body segment motions, and complete motions when assigning weights to the filler data. The filler data motion's final estimated values are calculated through the assigned weights and the values and metrics of similar motions. If a real time motion is completed, the filler data is removed from the SSBP and the real time motion is stored 450.

Once the simulated, or filler, data is completed and archived, the trajectory analysis 805 needs to be run for each motion in the SSBP 450. For this detailed example, every single real data motion 300 and simulated motion 450 is run through the trajectory analysis 805. The trajectory analysis 805 process for simulated, or filler, data is the same as the real time motion's trajectory analysis 805. The simulated data and metrics is stored in the SSBP 450. The software searches for motions 300 that do not have trajectory analysis 805 data. If it doesn't have trajectory analysis 805, the trajectory analysis 805 algorithm is completed and the outputted data is stored 450 with the motion in the SSBP. As described above, the trajectory analysis 805 runs the equipment simulation 802, which leads to the trajectory 805 algorithm, which leads to the analyzation of the trajectory 805 data.

The user is then instructed to complete a ‘Utility Function’ 700. The ‘Utility Function’, or simply Utility Function 700, quantifies the user's desired results 700. The Utility Function 700 uses a series of toggles for key categories including, but not limited to, power (or distance), accuracy (or fairway percentage), and risk of injury (or statistical chance the motion 709 causes an injury).

When a user moves the toggle, other toggles respond accordingly. It is common knowledge that when an athlete increases the speed and power of a swing, the accuracy will decrease and the risk of injury will increase. The toggles use a regression equation to adjust the ‘dormant’ toggles when an ‘active’ toggle is moved. The regressions equation uses data from all results with respect to key analytics during the motion. The key analytics are calculated 600 through the data from the sensors 200.

Once a user decides on their desired results 700, the data is used in the optimal motion algorithm 708. The data acts as a guide for the algorithm to choose the right optimal motion 708 for the users desired results 700. The optimal motion algorithm 708 has to decipher between many different possible motions 450 that produce similar and acceptable results. The Utility Function 700 allows the optimal motion algorithm 708 to assign weights for key attributes that the user prefers. This is necessary for the optimal motion algorithm 708 so bias and blindness doesn't occur.

This detailed example doesn't describe the exact proprietary optimal motion algorithm 708, but details how the optimal motion algorithm 708 works. The system searches the database of collected motions, more specifically the SSBP 450, to compare motions and trajectories 805. The system uses the Utility Function 700 to train the search function so the motion 300 data with the acceptable amount of risk of injury and the trajectory 805 with the acceptable amount of accuracy and power is chosen. The system continues to search every possible golf swing. The Utility Function 700 not only provides minimum acceptable values but weights for which the end user values more. For example many motions 300 meet the minimum acceptable values and many exceed those values. The algorithm uses the user preference on which motion is ideal for the user. The algorithm finds the motion 300 with the highest correlation with the Utility Function 700 weights and chooses that motion 300 over more deviated, e.g. higher accuracy and less power, motion 300. In other words, the system completely searches the database for the best motion 300 that at minimum meets the acceptable values and at best correlates with the preferences of the Utility Function 700.

As described earlier in this patent, the optimal motion 708 considers the physics and biomechanics of the motion 300 (in particular specific location in each muscle) when calculating metrics and values programmed into the trajectory analysis 805. When considering how physics and biomechanics influence the trajectory 805 one can look at how the golf club 802 is effected by motion. This correlation in turn influences the impact statistics 804 and the trajectory analysis 805.

There are multiple different ways to complete the optimization process, some of which are included in the overview, but for the example the trajectory analysis 805 only will need to be run on filler data because the trajectory analysis 805 is run on every real time motion 300 recognized by the motion recognition algorithm 425.

The trajectory analysis 805 of each and every filler data motion 300 is completed in this example, but technically doesn't need to occur with the proprietary search function. The proprietary search function saves tons of computing power and time. This example doesn't include the proprietary search function and runs trajectory 805 on every motion 300, but the scope of this patent doesn't require that every possible motion 300 have trajectory analysis 805 run on it. The scope does include that for an optimal motion 708 to be deemed optimal a trajectory analysis 805 must be run on it and used as a factor in the comparison of potential ‘optimal motion’.

### Detailed Example of Workout

This detailed example of the Optimal Workout algorithm 750 highlights two different processes to achieve an Optimal Workout 750 for the end users desired results 700. Even though the patent details two different process, the invention claims the ability to run trajectory analysis 805 on predicted future MAUP values, metrics, biometric statistics, and other statistics. The invention also claims the ability to compare future trajectories 805 with the current trajectory 805 and provide statistics on the changes in trajectories 805. The invention also claims the ability to produce statistics on how each individual workout, session workout, and complete long term workout will affect the trajectory 805 results.

As stated above, while wearing the garment 100 with the sensors 200 the user completes a motion 300. The data is sent from the sensors 200 to the phone 204 and then to the server 205 where calculations are performed. The analyzation of the data from raw signals to analyzed data is performed. The position and orientation of each sensor is solved for. A motion is produced and analytics are performed on that motion.

After the initial calculation are preformed, the motion recognition algorithm 425 is implemented. The motion recognition algorithm 425 searches for unique motions and if found (e.g. golf swing) the motion is stored in the Sport Specific Biometric Profile 450 as detailed above.

As described above, the raw data, analyzed data, motion metrics, trajectory 805 data, trajectory 805 metrics, and all other relevant data is archived in a server 205 or anything similar in nature. Since the motion recognition software 425 recognizes the motion 300 as a golf swing, the server 205 may or may not store them in a database of all motions (known as the Biometric Profile 450, or BP 450) and/or a specific database only for golf swings (known as the Sport Specific Biometric Profile 450, or SSBP 450). For instance, the SSBP 450 contains every golf swing and its respective relevant data ever completed while the user wears the said garment 100.

As described above, the invention then estimates all data values that have not yet been collected and calculated through the garment 100 technology. The invention refers to this particular data as simulated data or filler data. The filler data is completed in the same manner as described above.

Once the simulated, or filler, data is completed and archived, the trajectory analysis 805 needs to be run of each motion 300 in the SSBP 450. For this detailed example, every single real data motion 300 and simulated motion is run through the trajectory analysis 805. The trajectory analysis 805 process for simulated, or filler, data is the same as the real time real data motion's trajectory analysis 805. The simulated data and metrics is stored in the SSBP 450. The software searches for motions 300 that do not have trajectory analysis 805 data. If it doesn't have trajectory analysis 805, the trajectory analysis 805 algorithm is completed and the outputted data is stored 450 with the motion. As described above, the trajectory analysis 805 runs the equipment simulation 802, which leads to the trajectory 805 algorithm, which leads to the analyzation of the trajectory 805 data.

As described above, the user completes an optimal motion 708 ‘Utility Function’. The Utility Function 700 uses a series of toggles for key categories including, but not limited to, power (or distance), accuracy (or fairway percentage), and risk of injury (or statistical chance the motion 708 causes an injury). This Utility Function 700 is exactly the same as above.

As described above, the system searches the database of collected motions, more specifically the SSBP 450, to compare motions, trajectories 805, and their respective analytics. The optimal motion process is completed in this step of the Optimal Workout process 750.

The system uses the Utility Function 700 to train the search function so the motion 300 data with the acceptable amount of risk of injury and the trajectory 805 with the acceptable amount of accuracy and power is chosen. The system continues to search every possible golf swing 300. The Utility Function 700 not only provides minimum acceptable values but weights for which the end user values more. For example many motions 300 meet the minimum acceptable values and many exceed those values. The algorithm uses the user preference on which motion 300 is ideal for the user. The algorithm finds the motion 300 with the most correlation with the Utility Function 700 weights and chooses that motion 300 over more deviated, but higher accuracy and less power, motion 300. In other words, the system completely searches the database for the best motion 300 that at minimum meets the acceptable values and at best correlates with the preferences of the Utility Function 700.

As described earlier in this patent, the optimal motion 708 considers the physics and biomechanics of the motion 300 (in particular specific location in each muscle) when calculating metrics and values programmed into the trajectory analysis 805. The physics and biomechanics of the motion help determine factors including expected body segment deviations under different scenarios (e.g. under expected amount of fatigue (expected fatigue levels in hole 14), normal body segment deviations (hole 2)) and how expected body segment deviations will affect the trajectory. These metrics, value added and effective ratios, help decipher between motions with similar trajectories. The invention also uses physics and biomechanics to quantify how the golf club 802 is effected by the motion and effects the trajectory 802.

Similarly to the description above, the user is then instructed to complete a ‘Utility Function’. The ‘Utility Function’, or simply Utility Function 700, quantifies the user's desired results 700. The Optimal Workout Utility Function 700 uses a series of toggles for key categories, but these categories are different than the Optimal Motion Utility Function 700. The key categories for the Optimal Workout Algorithm 750 include frequency, intensity, duration, and duration of total program. These allow the user to inform the Optimal Workout Algorithm 750 on realistic training sessions.

Similar to the optimal motion 708 Utility Function 700, the toggles estimate how each toggle effects potential results. For example, the estimations show how an extra day a week working out at the normal intensity and duration will increase the users' results. The estimation is completed by the adding the expected changes in values including, but not limited to, calories, muscle hypertrophy, and increase in acceleration of the users' feet, to the total estimated results. By adding an extra day a week working out at the designated intensity and duration, the process concludes at the end of the workout program the athlete will increase muscle mass, decrease fat mass, increase metrics, among others by an added percentage or value of X.

The Utility Function 700 for the optimal motion 708 may include specific physical, metric, or trajectory 805 results as a guide for the optimal workout algorithm 750. By combining the two Utility Functions 700, the Optimal Workout Algorithm 750 can narrow down exact results desired. The user may also choose to specifically increase the muscle mass in a specific location/s, increase the MAUP values in a specific location/s, increase a specific metric (time until fatigue, acceleration), or increase a specific trajectory 805 result (distance, accuracy). This process allows the user to focus the Optimal Workout 750 to their desired results 700.

Once a user decides on their desired results 700, the data is used in the optimal motion algorithm 708. The data acts as a guide for the algorithm to choose the right optimal motion 708 for the users desired results 700. The optimal motion algorithm 708 has to decipher between many different possible motions 300 that produce similar and acceptable results. The Utility Function 700 allows the optimal motion algorithm 708 to assign weights for key attributes that the user prefers. This is necessary for the optimal motion algorithm 708 so bias and blindness doesn't occur.

Given the Optimal Workout Utility Function 700, an estimated amount of improvement can be quantified. This detailed example uses a series of equations that produces the maximum MAUP and metrics possible given the Optimal Workout Utility Function 700. This example considers a 3 workout a week for 1 hour each with a maximum intensity. The algorithm estimates how much the user can improve over a 6 month period. When considering a specific MAUP or metrics, the algorithm assumes that specific value is the primary target when the Optimal Workout program 750 is produced. This produces an estimated maximum value for the Optimal Workout process 750. The range minimum is the current values.

As described above, the system searches the database of collected motions 300, more specifically the SSBP 450, to compare motions, trajectories 805, and their respective analytics. The optimal motion process described above is completed in this step of the Optimal Workout process 750. This optimal motion process 708 differs because it does not search the SSBP 450, but the SSBP-FR 450 (or Sport Specific Biometric Profile-Future Results 450). The SSBP-FR 450 includes all motions in the SSBP 450. The difference between the SSBP 450 and the SSBP-FR 450 is all motions in the SSBP-FR 450 have different values and metrics. These values (MAUP, Resting Heart Rate, maximum force, ect) and metrics (velocity, force, time until fatigue, deviations when fatigue occur, ect) were estimated through the Utility Function 700 and equations described above. The SSBP-FR 450 includes every motion and every combination of values and metrics possible. If desired results 700 (or a specific results) is selected, the SSBP-FR 450 removes every motion that falls short of the desired results 700. The process of removing a motion (or MAUP and metrics inside the possible range) that falls short of the desired result depends on which desired result is selected. If the athlete wants to increase the max acceleration of the user's feet, the minimum requirements for that max acceleration is calculated. This may include, but not limited to, a combination of MAUP values, the amount of force produced from muscles involved in that motion, and fast twitch activation levels. Once a combination of values is deemed physically unable to produce the max acceleration desired, it is removed from the SSBP-FR 450. This allows for less searches.

The new optimal motion 708 with currently unattainable metrics, or referred to as the future optimal motion 708, is archived 709 in the server 205 or anything similar in nature. Data that is stored includes, but is not limited to, the timestamped motion of every body segment, the metrics with respect to the motion 709 (e.g. angular velocity, velocity), the MAUP values, the metrics with respect to muscle fibers (e.g. time until fatigue, activation rates, stress levels), and the metrics with respect to the heart (e.g. resting heart rate, expected heart rate).

Once the new optimal motion 708 with new estimated MAUP and metrics is produced and archived, the invention calculates the difference, or delta, between the current MAUP and metrics and the estimated MAUP and metrics. Once calculated, these delta values are inputted into the Optimal Workout Algorithm 750 and are used to inform the Optimal Workout Algorithm 750 what attributes and exact location in the muscles the user needs to improve. This input is similar to the Utility Function 700 which informs the Optimal Workout Algorithm 750 the duration, intensity, and frequency the user can expect to devote to working out.

Like the optimal motion algorithm 708, this detailed example doesn't describe the exact proprietary Optimal Workout Algorithm 750, but details how the Optimal Workout Algorithm 750 works. The system searches a database of collected individual workouts (a single workout that consists of repetitions and sets) to combine them in a way that produces the best possible results. The Optimal Workout Algorithm 750 considers positive ‘continuation values’ (each individual workout is beneficial to the previous individual workouts and future individual workouts), correlation between each individual workout and the desired trajectory 805 delta values in ideal muscle location (MAUP values, type of MAUP values, physics and biomechanics on how the increase in ideal muscle architecture will affect metrics), optimal motion ‘Utility Function’ 700 (working toward the users end goals/metrics and weighting individual workout results through what the user values more), Optimal Workout ‘Utility Function’ 700 (the expected duration, intensity, frequency of workouts, and length of time).

The selection continues to update throughout each day of individual workouts and throughout the entirety of the complete workout program. The process of selecting workouts adapts to how each muscle is responding to previous individual workouts, deltas in metrics, delta in loss of fast twitch muscle fibers (reduction in fatigue levels), heart rate, levels of latic acid, among many other variables.

Alternatively to step [0191], the invention may also only run trajectory analysis 805 on same motion but variable MAUP and metrics. Under this scenario, the user wants to keep their optimal motion 709, or golf swing, as similar as possible to their current optimal motion 709 but improve their game through weights. The optimal motion process 708 runs the same but instead of using the SSBP 450 as the database, it uses only the current optimal motion 709, or an extremely smaller database that is very close to the original optimal motion 709, with a range of metrics/data estimated in the Optimal Workout utility function 700. The optimal motion process 708 described above is completed. By focusing only on very similar or an exact motion the computing time and power is greatly reduced.

As described above, once the new optimal motion 708 with new estimated MAUP and metrics is produced and archived invention calculates the difference, or delta, between the current MAUP and metrics and the estimated MAUP and metrics. Once calculated, these delta values are inputted into the Optimal Workout Algorithm 750 and are used to inform the Optimal Workout Algorithm 750 what attributes and exact location in the muscles the user needs to improve. This is similar to the Utility Function 700 which informs the Optimal Workout Algorithm 750 the duration, intensity, and frequency the user can expect to devote to working out.

As described above, this detailed example doesn't describe the exact proprietary Optimal Workout Algorithm 750, but details how the Optimal Workout Algorithm 750 works. The system searches a database of collected individual workouts (a single workout that consists of repetitions and sets) to combine them in a way that produces the best possible results. The Optimal Workout Algorithm 750 is the same as described above.

The selection of individual workouts continues to update 751 throughout each day of individual workouts and throughout the entirety of the complete workout program. The process of selecting workouts adapts to how each muscle is responding to previous individual workouts, deltas in metrics, delta in loss of fast twitch muscle fibers (reduction in fatigue levels), heart rate, levels of latic acid, among many other variables.

The detailed example of the Optimal Workout 750 describes the process of taking raw data, converting it to a motion with metrics, running a trajectory analysis 805 of the motion, producing an optimal motion 708, and improving the optimal motion 708 (and in turn the trajectory 805 and the motions metrics) through an Optimal Workout plan 750.

The scope of this patent's claims includes an Optimal Workout plan 750 based off trajectory analysis 805 of a motion 300. The patent claims that by simulating future results of user through a workout, the optimal motion algorithm 708 can find the exact location and levels of increase needed to produce the desired trajectory 805. The detailed description describes the optimal motion 708 as the key influencer in the Optimal Workout process 750, but as described in the detailed example of the optimal motion 708, the optimal motion 708 is directly reliant on the initial claim that a trajectory 805 can be calculated from sensors 200 attached the garment 100.

The scope of the patent claims the ability to run trajectory analysis 805 on future motion 300 results currently unattainable. The scope also claims statistics between the trajectories 805 (current and future trajectory 805 results) and statistics on how each individual workout, sessions workout, and complete workout will affect the traj ectory 805 results.

I claim:

1. A computer-implemented method comprising:
identifying, by one or more computing devices and one or more sensors, an user's motion, the motion having metrics and analytics;
generating, by the one or more computing devices and the one or more sensors, motions data for unmonitored body parts, the motions having metrics and analytics;
generating, by the one or more computing devices and the one or more sensors, an archived database of all users' motions and motion's data;
generating, by the one or more computing devices and the data of one or more sensors, a simulation of equipment throughout the motion;
generating, by the one or more computing devices and the data of one or more sensors, a simulation of the impact and/or release between multiple equipment and/or equipment and the user, the impact and/or release having metrics and analytics;
determining, by the one or more computing devices and the data of one or more sensors, a trajectory of the equipment or user based on the impact and/or release data, trajectory having metrics and analytics;
updating, by the one or more computing devices and the data of one or more sensors, the archived database of all users' motions and motion's data to include equipment and trajectory information;
generating, by the one or more computing devices and the data of one or more sensors, a simulation of motions and motion's metrics and analytics, based on similar motions, which the computing devices and sensors have not collected and updating the archived database;
determining, by using the archive of motions, motion's metrics and analytics, motion's trajectory, and motion's trajectory metrics and analytics, an optimal motion based on the user's utility function;
generating, by the one or more computing devices and the data of one or more sensors, a simulation of potential metrics and analytics currently unattainable pertaining to a motion, based on the archived database of all users' motions and motion's data, and archiving the data in a database;
determining, by using the archive of motions with the currently unattainable simulated data, motion's metrics and analytics, motion's trajectory, and motion's trajectory metrics and analytics, an optimal workout based on the user's utility function;

2. The method of claim 1, wherein determining the trajectory includes:
equipment variables are estimated based on information produced from the computing devices and sensors.

3. The method of claim 2, wherein determining the trajectory includes:
impact/release variables are estimated based on information produced from the computing devices and sensors and the equipment variables.

4. The method of claim 3, wherein determining the trajectory includes:
trajectory variables are estimated based on information produced from the computing devices and sensors, the equipment variables, and the impact/release variables.

5. The method of claim 4, wherein determining the trajectory includes:
simulated trajectory metrics and analytics are generated based on the archived timestamped trajectory.

6. The method of claim 1, wherein determining the trajectory includes:
the computing devices and sensors variables, the equipment variables, the impact/release variables, and the trajectory variables are estimated and updated based on information produced from the computing devices and sensors after the non-simulated trajectory location/result is determined.

7. The method of claim 6, wherein determining the optimal motion includes:
the archived trajectories and their respective metrics and analytics are compared to identify the desired optimal motion based on the information in the optimal motion utility function.

8. The method of claim 5, wherein determining the optimal workout includes:
generating new values and metrics for each motion in the archived database based on the information in the optimal workout utility function.

9. The method of claim 8, wherein determining the optimal workout includes:
identifying a specific or series of individual motions that produce the value and metrics determined would produce the user's future desired results.

10. A system comprising one or more computing devices configured to:
identifying an user's motion, the motion having metrics and analytics;
generating motions data for unmonitored body parts, the motions having metrics and analytics;
generating an archived database of all users' motions and motion's data;
generating a simulation of equipment throughout the motion;
generating a simulation of the impact and/or release between multiple equipment and/or equipment and the user, the impact and/or release having metrics and analytics;
determining a trajectory of the equipment or user based on the impact and/or release data, trajectory having metrics and analytics;
updating the archived database of all users' motions and motion's data to include equipment and trajectory information;
generating a simulation of motions and motion's metrics and analytics, based on similar motions, which the computing devices and sensors have not collected and updating the archived database;
determining an optimal motion based on the user's utility function;
generating a simulation of potential metrics and analytics currently unattainable pertaining to a motion, based on the archived database of all users' motions and motion's data, and archiving the data in a database;
determining an optimal workout based on the user's utility function;

11. The system of claim 10, wherein determining the trajectory includes:
equipment variables are estimated based on information produced from the computing devices and sensors.

12. The system of claim 11, wherein determining the trajectory includes:
impact/release variables are estimated based on information produced from the computing devices and sensors and the equipment variables.

13. The system of claim 12, wherein determining the trajectory includes:
trajectory variables are estimated based on information produced from the computing devices and sensors, the equipment variables, and the impact/release variables.

14. The system of claim 13, wherein determining the trajectory includes:
simulated trajectory metrics and analytics are generated based on the archived timestamped trajectory.

15. The system of claim 10, wherein determining the trajectory includes:
the computing devices and sensors variables, the equipment variables, the impact/release variables, and the trajectory variables are estimated and updated based on information produced from the computing devices and sensors after the non-simulated trajectory location/result is determined.

16. The system of claim 15, wherein determining the optimal motion includes:
the archived trajectories and their respective metrics and analytics are compared to identify the desired optimal motion based on the information in the optimal motion utility function.

17. The system of claim 14, wherein determining the optimal workout includes:
generating new values and metrics for each motion in the archived database based on the information in the optimal workout utility function.

18. The system of claim 17, wherein determining the optimal workout includes:
identifying a specific or series of individual motions that produce the value and metrics determined would produce the user's future desired results.

19. A non-transitory computer-readable medium on which instructions are stored, the instructions, when executed by one or more processors cause the one or more processors to perform a method, the method comprising:
identifying, by one or more computing devices and one or more sensors, an user's motion, the motion having metrics and analytics;
identifying an user's motion, the motion having metrics and analytics;
generating motions data for unmonitored body parts, the motions having metrics and analytics;
generating an archived database of all users' motions and motion's data;
generating a simulation of equipment throughout the motion;
generating a simulation of the impact and/or release between multiple equipment and/or equipment and the user, the impact and/or release having metrics and analytics;
determining a trajectory of the equipment or user based on the impact and/or release data, trajectory having metrics and analytics;
updating the archived database of all users' motions and motion's data to include equipment and trajectory information;
generating a simulation of motions and motion's metrics and analytics, based on similar motions, which the computing devices and sensors have not collected and updating the archived database;
determining an optimal motion based on the user's utility function;
generating a simulation of potential metrics and analytics currently unattainable pertaining to a motion, based on the archived database of all users' motions and motion's data, and archiving the data in a database;

20. The method of claim 19, wherein determining the trajectory includes:
equipment variables are estimated based on information produced from the computing devices and sensors.

21. The method of claim 20, wherein determining the trajectory includes:
impact/release variables are estimated based on information produced from the computing devices and sensors and the equipment variables.

22. The method of claim 21, wherein determining the trajectory includes:
trajectory variables are estimated based on information produced from the computing devices and sensors, the equipment variables, and the impact/release variables.

23. The method of claim 22, wherein determining the trajectory includes:
simulated trajectory metrics and analytics are generated based on the archived timestamped trajectory.

24. The method of claim 19, wherein determining the trajectory includes:
the computing devices and sensors variables, the equipment variables, the impact/release variables, and the trajectory variables are estimated and updated based on information produced from the computing devices and sensors after the non-simulated trajectory location/result is determined.

25. The method of claim 24, wherein determining the optimal motion includes:
the archived trajectories and their respective metrics and analytics are compared to identify the desired optimal motion based on the information in the optimal motion utility function.

26. The method of claim 23, wherein determining the optimal workout includes:
generating new values and metrics for each motion in the archived database based on the information in the optimal workout utility function.

27. The method of claim 26, wherein determining the optimal workout includes:
identifying a specific or series of individual motions that produce the value and metrics determined would produce the user's future desired results.
